(19) United States
(12) Patent Application Publication
(10) Pub. No.: US 2026/0099000 A1
(43) Pub. Date: Apr. 9, 2026

(54) OPTICAL CONNECTION COMPONENT

(71) Applicants: SUMITOMO ELECTRIC INDUSTRIES, LTD., Osaka (JP); UTSUNOMIYA UNIVERSITY, Utsunomiya-shi (JP)

(72) Inventors: Shigehiro NAGANO, Osaka (JP); Tetsuya Nakanishi, Osaka (JP); Yoshio Hayasaki, Tochigi (JP); Satoshi Hasegawa, Tochigi (JP)

(73) Assignees: SUMITOMO ELECTRIC INDUSTRIES, LTD., Osaka (JP); UTSUNOMIYA UNIVERSITY, Utsunomiya-shi (JP)

(21) Appl. No.: 19/347,833

(22) Filed: Oct. 2, 2025

(30) Foreign Application Priority Data
Oct. 7, 2024 (JP) 2024-175671

(51) Int. Cl. G02B 6/122; G02B 6/13; G02B 6/12

(52) U.S. Cl. CPC G02B 6/122; G02B 6/13; G02B 2006/12038

(57) ABSTRACT

An optical connection component includes a glass member and an optical waveguide. In a refractive index distribution of the optical waveguide along a first direction, when the distance from the center to the outer edge of the optical waveguide along the first direction is denoted by r, the refractive index at the position of the outer edge is denoted by nr1.0, the refractive index at a position away from the center by 20% of the distance r is denoted by nr0.2, and the refractive index at a position away from the center by 80% of the distance r is denoted by nr0.8, the ratio (nr0.2/n1) of the refractive index nr0.2 to the refractive index n1 is 85% or more and 100% or less, and the ratio (nr0.8/n1) of the refractive index nr0.8 to the refractive index n1 is 8% or more and 75% or less.

### CROSS REFERENCE

The present application claims priority based on Japanese Patent Application No. 2024-175671 filed on October 7, 2024, the entire contents of which are incorporated herein by reference.

### TECHNICAL FIELD

The present disclosure relates to an optical connection component.

### BACKGROUND

Non-Patent Literature 1 (K. M. Davis, K. Miura, N. Sugimoto, and K. Hirao, “Writing waveguides in glass with a femtosecond laser,” Optics Letters, vol.21,No.21, pp1729-1731 (November 1,1996).), Non-Patent Literature 2 (Dezhi Tan, et al., “Femtosecond laser writing low-loss waveguides in silica glass: highly symmetrical mode field and mechanism of refractive index change,” Optical Materials Express, Vol.11, No.3 pp.848-857.), Non-Patent Literature 3 (Yusuke Nasu, Masaki Kohtoku, and Yoshinori Hibino, “Low-loss waveguides written with a femtosecond laser for flexible interconnection in a planar light-wave circuit,” Optics Letter, vol. 30, no. 7 (2005).), and Non-Patent Literature 4 (R. S. Taylor, et al., “Ultra-high resolution index of refraction profiles of femtosecond laser modified silica structures,” Optics Express, 2003, Vol. 11, No. 7, p.775.) disclose technologies in which an optical waveguide is formed by a drawing method using femtosecond laser beam. Non-Patent Literature 1 discloses a technology in which the refractive index of the inside a glass member is increased by application of femtosecond laser beam. Non-Patent Literatures 2 and 4 disclose technologies in which an optical waveguide is formed by single-scan writing of femtosecond laser beam. Non-Patent Literature 3 discloses a technology in which an optical waveguide having a square cross-sectional shape is formed by multi-scan writing of femtosecond laser beam.

Non-Patent Literature 5 (M. Lancry, et al., “Dependence of the femtosecond laser refractive index change thresholds on the chemical composition of doped-silica glasses”, Optical Materials Express, 2011, Vol. 1, No. 4, p. 711) discloses a technology in which the refractive index of the inside a glass member is increased by increasing pulse energy of femtosecond laser beam. Patent Literature 1 (WO 2023/095432 A) discloses a technology in which an optical waveguide is formed using a plurality of branched beams. Patent Literature 2 (WO 2022/255261 A) discloses a technology in which transmission loss is reduced by reducing variations in the outer diameter of a core.

### SUMMARY

An optical connection component of an embodiment of the present disclosure includes a glass member and an optical waveguide formed in the inside the glass member and having a higher refractive index than the glass member. In a cross section orthogonal to the direction in which the optical waveguide extends, the width of the optical waveguide along a first direction is equal to or different from the width of the optical waveguide along a second direction orthogonal to the first direction. In a refractive index distribution of the optical waveguide along the first direction, when the maximum value of the refractive index of the optical waveguide is denoted by n1 and the average value of the refractive indices of the region of the glass member excluding the optical waveguide is denoted by n2, the area of the refractive index n2 + 0.01% or more including the refractive index n1 is defined as the extent of the optical waveguide. When the distance from the center to the outer edge of the optical waveguide along the first direction is denoted by r, the refractive index at the position of the outer edge of the optical waveguide is denoted by nr1.0, the refractive index at a position away from the center of the optical waveguide by 20% of the distance r is denoted by nr0.2, and the refractive index at a position away from the center of the optical waveguide by 80% of the distance r is denoted by nr0.8, the ratio (nr0.2/n1) of the refractive index nr0.2 to the refractive index n1 is 85% or more and 100% or less, and the ratio (nr0.8/n1) of the refractive index nr0.8 to the refractive index n1 is 8% or more and 75% or less.

### BRIEF DESCRIPTION OF THE DRAWINGS

FIG. 1A is a diagram showing a configuration of a manufacturing apparatus that manufactures an optical connection component of an embodiment;

FIG. 1B is a diagram for describing scanning of laser beam by the manufacturing apparatus of FIG. 1A;

FIG. 2 is a diagram showing a configuration of a beam shaping unit included in the manufacturing apparatus of FIG. 1A;

FIG. 3A is a diagram showing changes of the state of the wavefront of laser beam along the major axis direction;

FIG. 3B is a diagram showing changes of the state of the wavefront of laser beam along the minor axis direction;

FIG. 3C is a diagram showing a beam irradiation region of laser beam at a focal point;

FIG. 4A is a diagram showing a beam irradiation region of laser beam having a light intensity distribution of a flat-top shape;

FIG. 4B is a diagram showing a process of forming an optical waveguide in the inside a glass member;

FIG. 5 is a perspective view schematically showing an optical connection component manufactured by the manufacturing apparatus of FIG. 1A;

FIG. 6 is a graph showing a refractive index distribution of the optical waveguide along the major axis direction;

FIG. 7 is a graph showing a relationship between the pulse energy of laser beam and the refractive index difference of the optical waveguide with respect to the glass member;

FIG. 8 is a flowchart for describing an example of a manufacturing method of the present embodiment;

FIG. 9 is a flowchart for describing an example of steps included in FIG. 8;

FIG. 10A is a diagram showing changes of the state of the major axis wavefront of laser beam shaped by a manufacturing apparatus of a comparative example;

FIG. 10B is a diagram showing changes of the state of the minor axis wavefront of laser beam shaped by the manufacturing apparatus of the comparative example;

FIG. 10C is a diagram showing a beam irradiation region of laser beam condensed by the manufacturing apparatus of the comparative example;

FIG. 11 is a diagram showing a beam cross section along the optical axis direction of laser beam condensed by the manufacturing apparatus of the comparative example;

FIG. 12A is a diagram showing a cross-sectional shape of an optical waveguide that is formed in the inside a glass member by the manufacturing apparatus of the comparative example;

FIG. 12B is a diagram showing a shape of a waveguiding mode of propagation through the optical waveguide shown in FIG. 12A;

FIG. 13 is a diagram showing a beam cross section along the optical axis direction of laser beam condensed by the manufacturing apparatus of FIG. 1A;

FIG. 14A is a diagram showing an image of a cross-sectional shape of an optical waveguide that is formed in the inside a glass member by the manufacturing apparatus of FIG. 1A; and

FIG. 14B is a diagram showing a shape of a waveguiding mode of propagation through the optical waveguide shown in FIG. 14A.

### DETAILED DESCRIPTION

Problem to be Solved by Present Disclosure

In the technologies of Non-Patent Literatures 1 and 2, the width in the lateral direction of the optical waveguide formed in the inside the glass member is as narrow as 2 μm or less; therefore, the optical waveguide does not function as a waveguide, or even if light successfully propagates through the inside the optical waveguide, bending loss is large because the confinement of light is small. In this respect, in the technology of Non-Patent Literature 3, the width in the lateral direction of the optical waveguide is adjusted by scanning laser beam 20 times while shifting laser beam in a direction orthogonal to the optical axis of laser beam. However, in this technology, since the time spent to form one optical waveguide is 20 times the time in the case of single-scan writing, there is a problem that the productivity of optical connection components is significantly reduced. In the technology of Patent Literature 1, hologram technology is used to divide one beam of laser beam into a plurality of diffracted light beams, and the plurality of diffracted light beams are used to simultaneously form a plurality of optical waveguides by one scan.

However, in the technologies of Non-Patent Literature 3 and Patent Literature 1, the refractive index distribution of the optical waveguide formed by application of laser beam is a step-index type reflecting steep changes in the light intensity of laser beam, and the refractive index difference at the boundary between the optical waveguide (core) and the surrounding region (cladding) becomes large. A predominant factor in the transmission loss of the optical waveguide is variations in the shape of the boundary between the core and the cladding due to fluctuations in the power of the laser beam source, shifts of pointing, vibration of the stage, etc.; thus, transmission loss may increase with increase in the refractive index difference at the boundary between the core and the cladding.

The present disclosure provides an optical connection component capable of reducing light transmission loss.

### Effects of Present Disclosure

By the optical connection component according to the present disclosure, light transmission loss can be reduced.

### Description of Embodiments of Present Disclosure

First, the contents of an embodiment of the present disclosure are enumerated and described.

(1) An optical connection component of an embodiment of the present disclosure includes a glass member and an optical waveguide formed in the inside the glass member and having a higher refractive index than the glass member. In a cross section orthogonal to the direction in which the optical waveguide extends, the width of the optical waveguide along a first direction is equal to or different from the width of the optical waveguide along a second direction orthogonal to the first direction. In a refractive index distribution of the optical waveguide along the first direction, when the maximum value of the refractive index of the optical waveguide is denoted by n1 and the average value of the refractive indices of the region of the glass member excluding the optical waveguide is denoted by n2, the area of the refractive index n2 + 0.01% or more including the refractive index n1 is defined as the extent of the optical waveguide. When the distance from the center to the outer edge of the optical waveguide along the first direction is denoted by r, the refractive index at the position of the outer edge of the optical waveguide is denoted by nr1.0, the refractive index at a position away from the center of the optical waveguide by 20% of the distance r is denoted by nr0.2, and the refractive index at a position away from the center of the optical waveguide by 80% of the distance r is denoted by nr0.8, the ratio (nr0.2/n1) of the refractive index nr0.2 to the refractive index n1 is 85% or more and 100% or less, and the ratio (nr0.8/n1) of the refractive index nr0.8 to the refractive index n1 is 8% or more and 75% or less.

As described above, in the conventional technology, an optical waveguide having a refractive index distribution of a step-index type may be formed. In this case, there is a problem that transmission loss is increased by non-uniformity of the optical waveguide due to the laser beam source and the optical system. In contrast, in the above optical connection component, the refractive index distribution of the optical waveguide along the first direction can be made a graded index type, a Gaussian type, or an α-th power type in which the refractive index difference at the boundary between the optical waveguide (core) and the surrounding region (cladding) is reduced. In an optical waveguide thus having a refractive index distribution with a small refractive index difference, even if non-uniformity occurs with the optical waveguide due to the laser beam source and the optical system, transmission loss due to the non-uniformity can be reduced.

(2) In the optical connection component according to the above (1), the distance r may be 2 μm or more and 5 μm or less. In this case, an optical waveguide having an appropriate size capable of reducing transmission loss can be obtained.

(3) In the optical connection component according to the above (1) or (2), the refractive index difference of the refractive index n1 with respect to the refractive index n2 may be 0.2% or more and 0.5% or less. In this case, the refractive index difference at the boundary between the optical waveguide (core) and the surrounding region (cladding) can be made smaller, and therefore transmission loss can be reduced more effectively.

### Details of Embodiment of Present Disclosure

Specific examples of an optical connection component of an embodiment of the present disclosure will now be described with reference to the drawings. The present disclosure is not limited to these examples, but is indicated by the claims, and is intended to include all alterations within the meaning and scope equivalent to the claims. In the following description, the same elements are denoted by the same reference signs in the description of the drawings, and a repeated description is omitted as appropriate.

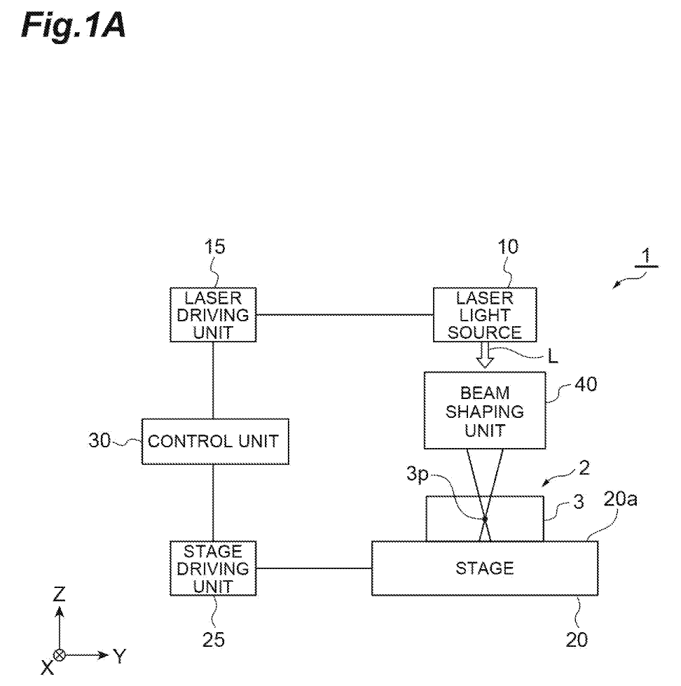

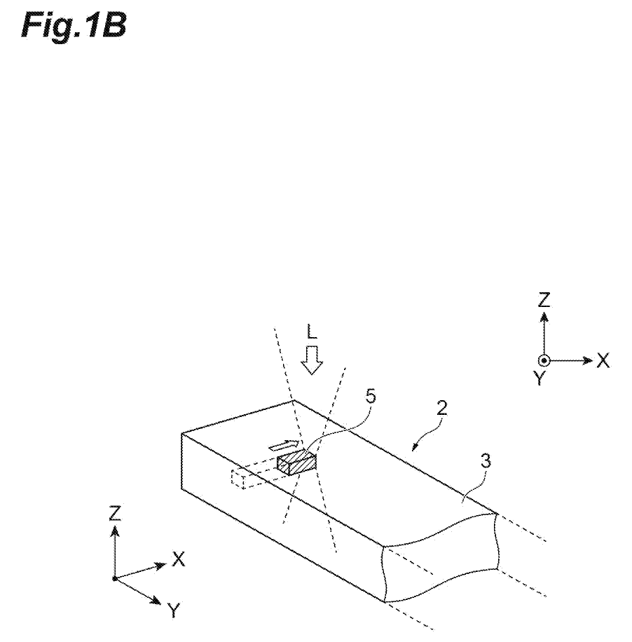

FIG. 1A is a diagram schematically showing a manufacturing apparatus 1 that manufactures an optical connection component 2 of the present embodiment. FIG. 1B is a diagram for describing scanning of laser beam L by the manufacturing apparatus 1. In each drawing, an XYZ orthogonal coordinate system is shown. The manufacturing apparatus 1 shown in FIG. 1A applies laser beam L to a glass member 3, and thereby manufactures an optical connection component 2 in which an optical waveguide 5 is formed in the inside the glass member 3. The glass member 3 is, for example, in a plate-shaped shape of which the thickness direction is a Z-axis direction. Hereinafter, a direction intersecting the Z-axis direction is referred to as an X-axis direction (a second direction), and a direction intersecting both the X-axis direction and the Z-axis direction is referred to as a Y-axis direction (a first direction).

As shown in FIG. 1A, the manufacturing apparatus 1 includes a laser beam source 10, a laser driving unit 15, a stage 20, a stage driving unit 25, a control unit 30, and a beam shaping unit 40.

The laser beam source 10 emits pulsed laser beam L for forming an optical waveguide 5 (see FIG. 1B) toward the inside the glass member 3 mounted on the stage 20. The laser beam source 10 is, for example, a femtosecond laser capable of emitting femtosecond laser beam as laser beam L. The laser beam L has an amount of energy that causes a refractive index change based on photoinduction to the glass member 3, and has a repetition frequency of 10 kHz or more. The refractive index change based on photoinduction means a refractive index change that is induced in the inside the glass member 3 by light irradiation of laser beam L or the like. The refractive index change is defined by the maximum refractive index difference in the light irradiation region, where a refractive index change has occurred, with the refractive index of the region other than the light irradiation region as a reference. The amount of energy that causes a refractive index change based on photoinduction to the glass member 3 refers to, for example, a peak power of 10⁵ W/cm² or more.

The repetition frequency of laser beam L is, for example, 10 kHz or more and 5 MHz or less. By the repetition frequency being 10 kHz or more, the refractive index and structure of the optical waveguide 5 formed in the inside the glass member 3 can be smoothed. The pulse width of laser beam L is, for example, 500 fs (femtoseconds) or less. The pulse width is defined as the time interval between points at which the amplitude is 50% of the maximum amplitude. The wavelength of laser beam L is, for example, in the range of -10 nm or more and +10 nm or less with 1030 nm as a reference or in the range of -10 nm or more and +10 nm or less with 1060 nm as a reference, or a result of second harmonic generation (SHG) in each wavelength range or a result of third harmonic generation (THG) in each wavelength range.

The laser driving unit 15 is connected to the laser beam source 10 and the control unit 30. In accordance with an instruction from the control unit 30, the laser driving unit 15 controls the power, pulse width, repetition frequency, etc. of laser beam L emitted from the laser beam source 10. The laser driving unit 15 includes, for example, an electronic circuit including a large-scale integrated circuit. The control unit 30 includes, for example, a computer including a CPU and a memory.

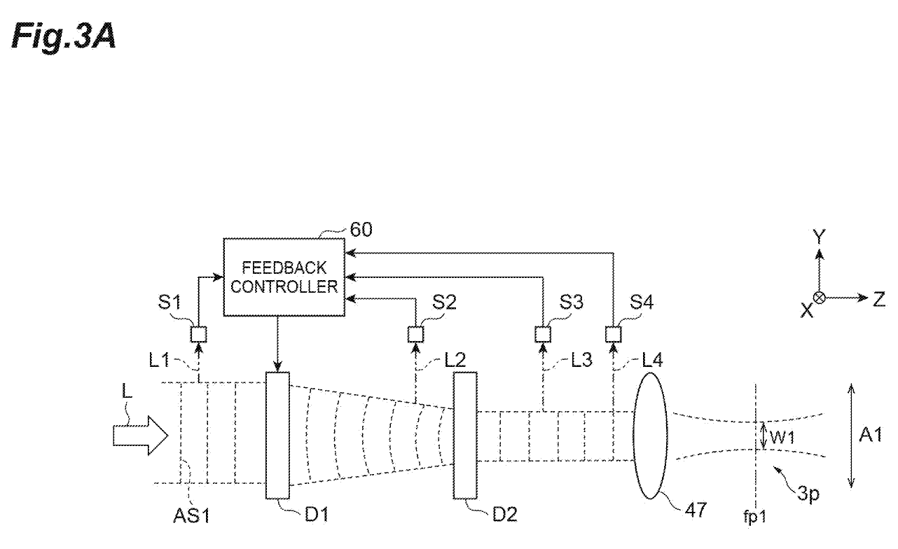

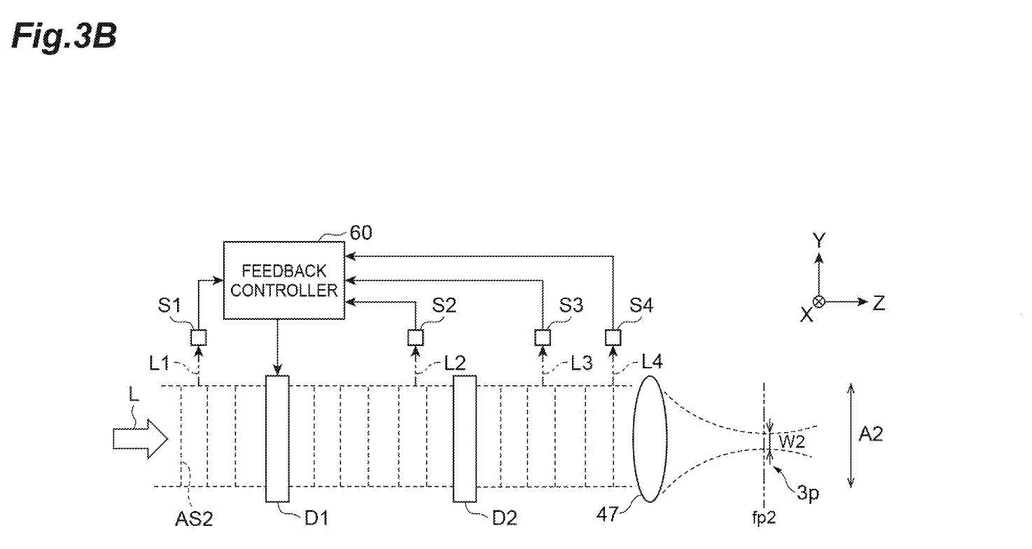

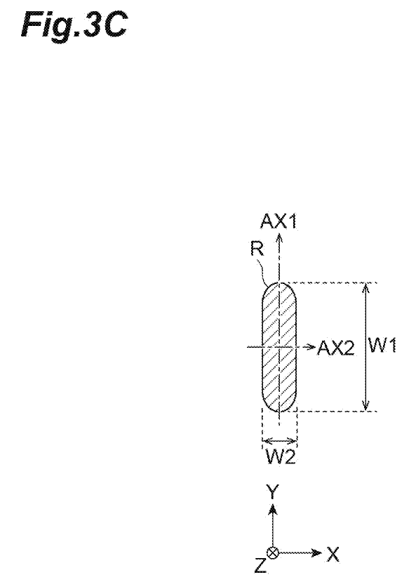

The beam shaping unit 40 is placed between the laser beam source 10 and the glass member 3. The beam shaping unit 40 condenses laser beam L emitted from the laser beam source 10 to a focal point 3p in the inside the glass member 3 mounted on the stage 20 while shaping the laser beam L into a desired shape. In the present embodiment, in a cross section (hereinafter, referred to as a “beam cross section”) orthogonal to the optical axis direction of laser beam L incident on the glass member 3, the laser beam L at the focal point 3p is shaped into, for example, an elliptical shape having a major axis AX1 and a minor axis AX2 orthogonal to each other (see FIG. 3C) or a line beam shape. The light intensity distribution along the major axis AX1 of laser beam L at the focal point 3p is in a Gaussian shape or a flat-top shape. The light intensity distribution along the minor axis AX2 of laser beam L at the focal point 3p is in a Gaussian shape. A detailed configuration of the beam shaping unit 40 will be described later.

The stage 20 includes a mounting surface 20a on which the glass member 3 is mounted. The mounting surface 20a is capable of moving along the X-axis direction, the Y-axis direction, and the Z-axis direction. The stage 20 can move the glass member 3 relative to the beam shaping unit 40. The stage driving unit 25 is connected to the control unit 30 and the stage 20. The stage driving unit 25 controls the position of the stage 20 in accordance with an instruction from the control unit 30.

By the stage 20 moving relative to the beam shaping unit 40, the position of the focal point 3p of laser beam L with respect to the glass member 3 moves relatively. Thereby, the scanning of laser beam L shown in FIG. 1B can be performed. In the example shown in FIG. 1B, laser beam L is applied to the glass member 3 in the Z-axis direction, and the focal point 3p of laser beam L moves along the X-axis direction. In this case, an optical waveguide 5 extending along the X-axis direction is formed in the inside the glass member 3. Thus, by the position of the focal point 3p of laser beam L with respect to the glass member 3 moving relatively, an optical waveguide 5 of an arbitrary pattern is formed in the inside the glass member 3.

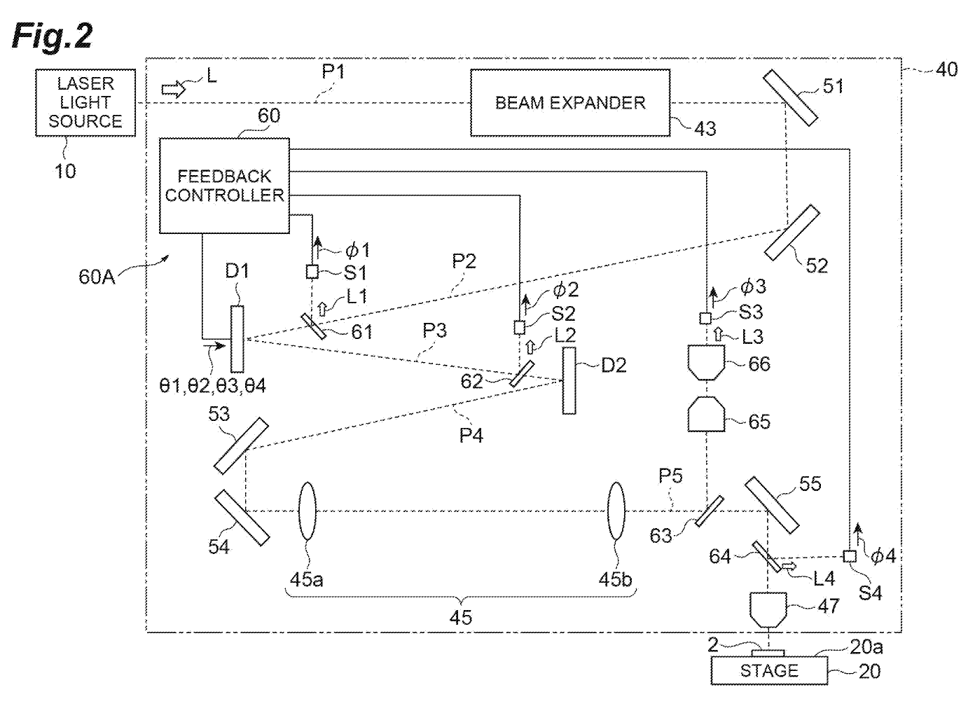

FIG. 2 is a diagram showing a configuration of the beam shaping unit 40. As shown in FIG. 2, the beam shaping unit 40 includes an expanding optical system 43, a first beam shaping element D1, a second beam shaping element D2, a reduction optical system 45, an objective lens 47 (a condensing lens), a plurality of mirrors 51, 52, 53, 54, and 55, and a feedback control mechanism 60A.

The expanding optical system 43 is placed on the optical path P1 of laser beam L emitted from the laser beam source 10. The expanding optical system 43 is, for example, a beam expander. The expanding optical system 43 collimates laser beam L emitted from the laser beam source 10 while increasing the beam diameter of the laser beam L. The beam diameter of laser beam L increased in diameter by the expanding optical system 43 is, although it depends on the size of the first beam shaping element D1, in the range of 5 mm or more and 30 mm or less, for example. Two mirrors 51 and 52 are arranged between the expanding optical system 43 and the first beam shaping element D1. Laser beam L that has passed through the expanding optical system 43 is reflected by the two mirrors 51 and 52, and is then guided to the first beam shaping element D1.

The first beam shaping element D1 is placed on the optical path P2 of laser beam L emitted from the expanding optical system 43. Laser beam L increased in diameter and collimated by the expanding optical system 43 is incident on the first beam shaping element D1. The first beam shaping element D1 shapes the laser beam L such that the width in the major axis direction A1 of the beam shape in the beam cross section is different from the width in the minor axis direction A2. At the focal point 3p, the major axis direction A1 means the direction in which the major axis AX1 extends; before condensation to the focal point 3p, the major axis direction A1 means the direction in which an axis corresponding to the major axis AX1 extends in an arbitrary beam cross section along the optical axis direction of laser beam. At the focal point 3p, the minor axis direction A2 means the direction in which the minor axis AX2 extends; before condensation to the focal point 3p, the minor axis direction A2 means the direction in which an axis corresponding to the minor axis AX2 extends in an arbitrary beam cross section along the optical axis direction of laser beam.

In the present specification, when “beam shape” is simply mentioned, it means the shape of a beam cross section in an arbitrary position along the optical axis direction of laser beam. In an arbitrary position along the optical axis direction of laser beam, the “beam shape” is defined by the contour of a region where both the light intensity of laser beam L along the major axis direction A1 and the light intensity of laser beam L along the minor axis direction A2 individually are 1/e² of the maximum light intensity.

The first beam shaping element D1 shapes the beam shape of laser beam L into a shape extended in one direction, for example, an elliptical shape or a line beam shape. For example, the first beam shaping element D1 condenses laser beam L only in the major axis direction A1, and thereby makes the width in the major axis direction A1 of the beam shape smaller than the width in the minor axis direction A2. The first beam shaping element D1 condenses laser beam L in the major axis direction A1 such that, at the second beam shaping element D2 away from the first beam shaping element D1 by a predetermined optical distance, the ratio between the width in the major axis direction A1 and the width in the minor axis direction A2 of the beam shape is, for example, 10. Strictly speaking, since collimated light is to be formed after the second beam shaping element D2, the first beam shaping element D1 and the second beam shaping element D2 are arranged such that their focal lengths coincide with each other. In the minor axis direction A2, the first beam shaping element D1 maintains laser beam L as collimated light without condensing the laser beam L. The first beam shaping element D1 may condense laser beam L in both the major axis direction A1 and the minor axis direction A2. In this case, the first beam shaping element D1 may set the light-gathering power in the major axis direction A1 larger than the light-gathering power in the minor axis direction A2 so that the width in the major axis direction A1 of the beam shape becomes smaller than the width in the minor axis direction A2.

The first beam shaping element D1 is, for example, a diffractive optical element (hologram optical element) including a phase modulation surface in which a plurality of pixels are two-dimensionally arranged. In this case, the first beam shaping element D1 modulates the phase of laser beam L by means of a phase pattern (hologram) presented on the phase modulation surface. Thereby, the first beam shaping element D1 shapes the beam shape of laser beam L into a shape extended in one direction, such as an elliptical shape or a line beam shape. The first beam shaping element D1 is, for example, an LCoS (liquid crystal on silicon) capable of dynamically switching a phase pattern presented on a phase modulation surface. Hereinafter, the variable LCoS is referred to as an LCoS-SLM (liquid crystal on silicon-based spatial light modulator).

The first beam shaping element D1 is electrically connected to the feedback control mechanism 60A. The first beam shaping element D1 presents, on the phase modulation surface, phase patterns according to correction signals θ1, θ2, θ3, and θ4 provided from the feedback control mechanism 60A. The first beam shaping element D1 may modulate the light intensity distribution of laser beam L to a desired light intensity distribution by modulation of the phase of laser beam L according to a phase pattern. For example, in the case where the light intensity distribution along the major axis AX1 of laser beam L at the focal point 3p is to be made a flat-top shape, the first beam shaping element D1 may modulate the phase of laser beam L such that the light intensity distribution in the major axis direction A1 of laser beam L is in a distribution shape represented by a sinc function. The first beam shaping element D1 emits shaped laser beam L toward the second beam shaping element D2.

The second beam shaping element D2 is placed on the optical path P3 of laser beam L emitted from the first beam shaping element D1. Laser beam L shaped by the first beam shaping element D1 is incident on the second beam shaping element D2. The second beam shaping element D2 shapes laser beam L after shaping by the first beam shaping element D1 such that the wavefront of the laser beam L becomes a planar.

The second beam shaping element D2 is, for example, a diffractive optical element (hologram optical element) that modulates the phase of laser beam L by means of a phase pattern (hologram) presented on a phase modulation surface. The second beam shaping element D2 is, for example, a bulk DOE (diffractive optical element) that statically presents a phase pattern on a phase modulation surface. Statically presenting a phase pattern on a phase modulation surface means that one phase pattern is formed on the phase modulation surface, and means that the phase pattern presented on the phase modulation surface is not configured to be switchable (i.e., cannot be switched). The second beam shaping element D2 modulates the phase of laser beam L by means of a phase pattern formed on the phase modulation surface such that the wavefront of laser beam L becomes a plane, for example. The second beam shaping element D2 emits laser beam L after shaping toward the reduction optical system 45 away from the second beam shaping element D2 by a predetermined optical distance.

The reduction optical system 45 is placed on the optical path P4 of laser beam L between the second beam shaping element D2 and the objective lens 47. Two mirrors 53 and 54 are arranged between the second beam shaping element D2 and the reduction optical system 45. Laser beam L emitted from the second beam shaping element D2 is reflected by the two mirrors 53 and 54, and is then guided to the reduction optical system 45. The reduction optical system 45 is an optical system that reduces the beam shape of laser beam L emitted from the second beam shaping element D2 in a state of maintaining the laser beam L as collimated light. The reduction optical system 45 includes, for example, a pair of lenses 45a and 45b. The pair of lenses 45a and 45b are arranged in line in a direction along the optical axis of laser beam L reflected by the mirror 54.

The reduction optical system 45 reduces the beam shape of laser beam L such that each of the widths in the major axis direction A1 and the minor axis direction A2 of the beam shape of laser beam L becomes equal to or smaller than the aperture diameter of the objective lens 47. For example, assuming that the width in the major axis direction A1 of the beam shape of laser beam L is 1, the reduction optical system 45 reduces the width in the major axis direction A1 in the range of 0.1 to 0.9. The reduction optical system 45 emits the reduced laser beam L toward the objective lens 47 away from the reduction optical system 45 by a predetermined optical distance. The reduction optical system 45 may not necessarily be used, and can be omitted as appropriate.

The objective lens 47 is placed on the optical path P5 of laser beam L between the reduction optical system 45 and the glass member 3. A mirror 55 is placed between the reduction optical system 45 and the glass member 3. Laser beam L emitted from the reduction optical system 45 is reflected by the mirror 55, and is then guided to the objective lens 47. Laser beam L of which the beam shape has been reduced by the reduction optical system 45 is incident on the objective lens 47. The objective lens 47 condenses laser beam L emitted from the reduction optical system 45 to a focal point 3p in the inside the glass member 3. The beam shape at the focal point 3p is, for example, a shape elongated in one direction, such as an elliptical shape or a linear beam shape. The optical axis of the objective lens 47 is, for example, placed along the Z-axis direction. Therefore, laser beam L emitted from the objective lens 47 is incident on the glass member 3 along the Z-axis direction. The numerical aperture (NA) of the objective lens 47 is, for example, 0.1 or more and 1.3 or less. An oil immersion high NA type may be used for the objective lens 47.

FIG. 3A is a diagram showing changes of the state of the wavefront of laser beam L along the major axis direction A1. FIG. 3B is a diagram showing changes of the state of the wavefront of laser beam L along the minor axis direction A2. FIG. 3C is a diagram showing a beam irradiation region R of laser beam L at the focal point 3p. Hereinafter, the wavefront of laser beam L along the major axis direction A1 is referred to as a “major axis wavefront AS1”, and the wavefront of laser beam L along the minor axis direction A2 is referred to as a “minor axis wavefront AS2”.

As shown in FIGS. 3A and 3B, both the major axis wavefront AS1 and the minor axis wavefront AS2 of laser beam L traveling toward the first beam shaping element D1 (that is, laser beam L before condensation to the focal point 3p) are plane surfaces. When laser beam L is incident on the first beam shaping element D1, the first beam shaping element D1 shapes the laser beam L to condense the laser beam L in the major axis direction A1. At this time, as shown in FIG. 3A, the major axis wavefront AS1 of laser beam L changes from a plane surface to a concave surface. On the other hand, as shown in FIG. 3B, the first beam shaping element D1 maintains the minor axis wavefront AS2 of laser beam L as a plane surface. As a result, the beam shape of laser beam emitted from the first beam shaping element D1 is shaped into a shape extended in one direction.

Next, as shown in FIGS. 3A and 3B, when laser beam L is incident on the second beam shaping element D2, the second beam shaping element D2 shapes the laser beam L such that both the major axis wavefront AS1 and the minor axis wavefront AS2 of laser beam L become plane surfaces. Specifically, in the case where the first beam shaping element D1 condenses the major axis wavefront AS1 of laser beam L, the second beam shaping element D2 modulates the phase of laser beam L such that the major axis wavefront AS1 that has been changed to a concave surface becomes a plane surface, while maintaining the minor axis wavefront AS2 as a plane surface. However, in the case where the minor axis wavefront AS2 is not strictly maintained in a plane surface, the second beam shaping element D2 may modulate the phase of laser beam L such that both the major axis wavefront AS1 and the minor axis wavefront AS2 become strictly plane surfaces.

After that, laser beam L is incident on the objective lens 47 in a state where both the major axis wavefront AS1 and the minor axis wavefront AS2 are plane surfaces. The objective lens 47 condenses laser beam L to the focal point 3p. As shown in FIGS. 3A and 3B, the width in the major axis direction A1 of the beam shape of laser beam L incident on the objective lens 47 is smaller than the width in the minor axis direction A2 of the beam shape. For example, the width in the major axis direction A1 of the beam shape is smaller than the aperture diameter of the objective lens 47, and the width in the minor axis direction A2 of the beam shape is the same as the aperture diameter of the objective lens 47. In this case, the objective lens 47 condenses laser beam L in the minor axis direction A2 up to the diffraction limit. On the other hand, the width in the major axis direction A1 of the beam shape is smaller than the aperture diameter of the objective lens 47, and therefore the objective lens 47 cannot completely narrow laser beam L in the major axis direction A1.

Thus, the objective lens 47 condenses laser beam L more largely in the minor axis direction A2 than in the major axis direction A1. As a result, the width W1 in the major axis direction A1 of the beam shape of laser beam L after condensation by the objective lens 47 is larger than the width W2 in the minor axis direction A2 of the beam shape after condensation which has been narrowed up to the diffraction limit. As a result, as shown in FIG. 3C, the beam shape at the focal point 3p is an elliptical shape having a minor axis AX2 and a major axis AX1. The beam shape of laser beam L at the focal point 3p corresponds to the beam irradiation region R shown in FIG. 3C. At the focal point 3p, the major axis direction A1 coincides with the Y-axis direction, and the minor axis direction A2 coincides with the X-axis direction.

The beam irradiation region R shown in FIG. 3C is, for example, in an elliptical shape having a minor axis AX2 and a major axis AX1 longer than the minor axis AX2. The major axis AX1 and the minor axis AX2 are axes orthogonal to the optical axis direction of laser beam L, and are orthogonal to each other. The length of the major axis AX1 corresponds to the width W1 along the major axis direction A1 of the beam irradiation region R. The length of the minor axis AX2 corresponds to the width W2 along the minor axis direction A2 of the beam irradiation region R. The length of the major axis AX1 is longer than the length of the minor axis AX2. The ratio of the length of the major axis AX1 to the length of the minor axis AX2, that is, the ratio (W1/W2) of the width W1 along the major axis direction A1 of the beam irradiation region R to the width W2 along the minor axis direction A2 of the beam irradiation region R is, for example, 2 or more and 20 or less, and is 10 in an example.

In the case where, in the course of passing through the first beam shaping element D1, the second beam shaping element D2, and the objective lens 47, the light intensity distribution of laser beam L is not adjusted and condensation into an elliptical shape or the like is simply performed, each of the light intensity distributions along the major axis direction A1 and the minor axis direction A2 of laser beam L at the focal point 3p is in a Gaussian shape. On the other hand, in the case where the first beam shaping element D1 adjusts the light intensity distribution in the major axis direction A1 of laser beam L such that the distribution becomes a shape represented by a sinc function, the light intensity distribution in the major axis direction A1 of laser beam L at the focal point 3p is converted to a flat-top shape. The light intensity distribution in the minor axis direction A2 of laser beam L at the focal point 3p may be in a Gaussian shape.

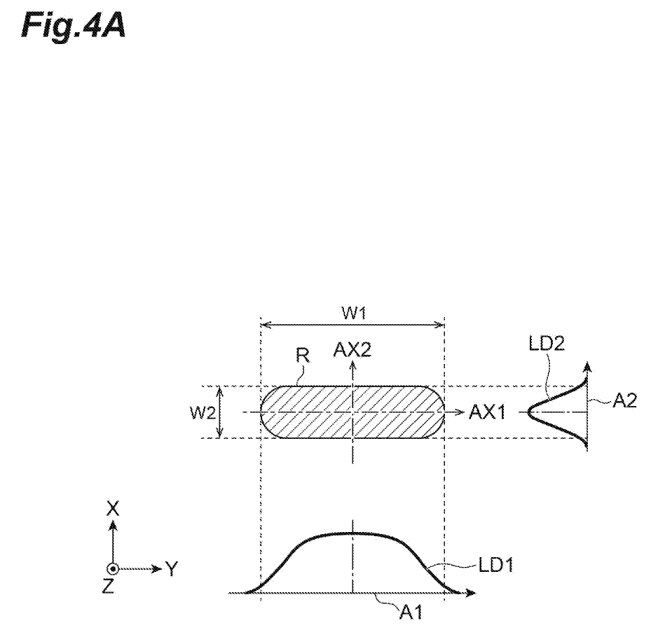

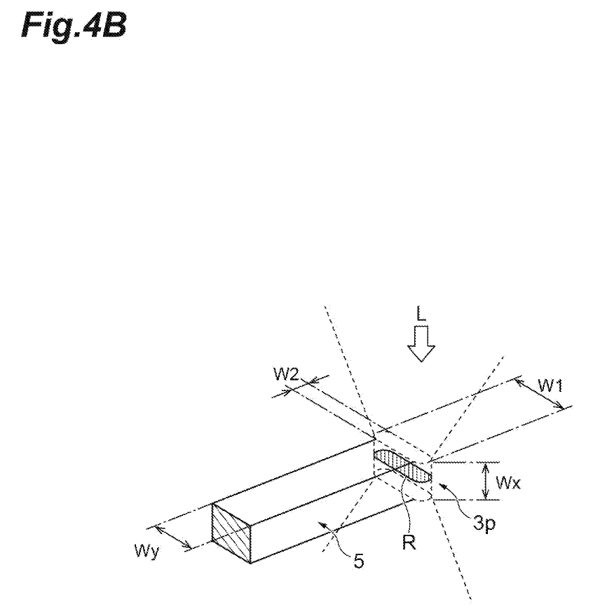

FIG. 4A is a diagram showing a beam irradiation region R of laser beam L having a light intensity distribution of a flat-top shape. FIG. 4B is a diagram showing a process of forming an optical waveguide 5 in the inside the glass member 3. In FIG. 4A, a light intensity distribution LD1 in the major axis direction A1 of laser beam L and a light intensity distribution LD2 in the minor axis direction A2 of laser beam L are shown together, and the flat-top shape of the beam irradiation region R is defined by the light intensity distributions LD1 and LD2. The beam irradiation region R is defined by the contour of a region where each of the light intensities of the light intensity distributions LD1 and LD2 is 1/e² of the maximum light intensity. In the region in a flat-top shape, when the distance from the center position in the major axis direction A1 is denoted by r, the full width at half maximum of the light intensity distribution LD1 along the major axis direction A1 is denoted by 2W, and the maximum light intensity of the light intensity distribution LD1 is denoted by P, the light intensity is 0.9P or more in the range of -0.9W ≤ r ≤ 0.9W, and 0.1P or less in the range of r ≤ -1.1W or 1.1W ≤ r.

As shown in FIG. 4B, the width W1 along the major axis direction A1 of the beam irradiation region R is adjusted such that the width Wy of an optical waveguide 5 to be formed is obtained. The width W2 along the minor axis direction A2 of the beam irradiation region R is adjusted such that a desired amount of refractive index change is obtained in the beam irradiation region R. By moving the focal point 3p of laser beam L along the X-axis direction (scanning direction) in the inside the glass member 3, an optical waveguide 5 is formed in the inside the glass member 3 by one scan. The width W1 in the major axis direction A1 of the beam irradiation region R contributes to the width Wy of the optical waveguide 5. The width W2 in the minor axis direction A2 of the beam irradiation region R contributes to the amount of refractive index change in the inside the glass member 3. The width W2 in the minor axis direction A2 of the beam irradiation region R can adjust, in addition to the amount of refractive index change, the width Wx in the thickness direction of the optical waveguide 5 (the Z-axis direction). In the case where the light intensity distribution along the major axis direction A1 of laser beam L at the focal point 3p is in a Gaussian shape, the inclination of the light intensity distribution is gentle. In this case, by narrowing the width W2 in the minor axis direction A2 of the beam irradiation region R, the modification threshold, which determines the width Wx of the optical waveguide 5, can be exceeded by addition of the light intensity distribution in the major axis direction A1 and the light intensity distribution in the minor axis direction A2. As a result, the width Wx of the optical waveguide 5 is extended.

FIGS. 3A and 3B will now be referred to again. As shown in FIGS. 3A and 3B, in the present embodiment, before laser beam L is incident on the objective lens 47, both the major axis wavefront AS1 and the minor axis wavefront AS2 of laser beam L are adjusted to become plane surfaces by the second beam shaping element D2. In this case, both the curvature of the major axis wavefront AS1 and the curvature of the minor axis wavefront AS2 are maintained at zero, and therefore a difference in curvature does not occur between the major axis wavefront AS1 and the minor axis wavefront AS2, or the difference is very small. When such laser beam L is condensed by the objective lens 47, the focal position fp1 of laser beam L for the major axis direction A1 coincides with the focal position fp2 of laser beam L for the minor axis direction A2, or is located in the vicinity of the focal position fp2. The focal position fp1 of laser beam L for the major axis direction A1 is the position of a beam waist occurring in the light intensity distribution of laser beam L along the major axis direction A1. The focal position fp2 of laser beam L for the minor axis direction A2 is the position of a beam waist occurring in the light intensity distribution of laser beam L along the minor axis direction A2.

Therefore, in the present embodiment, a difference in distance in the optical axis direction (astigmatism) between the focal position fp1 of laser beam L for the major axis direction A1 and the focal position fp2 of laser beam L for the minor axis direction A2 does not occur, or the difference is very small. For example, the difference in distance in the optical axis direction between the focal position fp1 of laser beam L for the major axis direction A1 and the focal position fp2 of laser beam L for the minor axis direction A2 is 0 μm or more and 10 μm or less. When the deviation between the focal positions fp1 and fp2 is thus reduced, distortion of the beam shape of laser beam L due to astigmatism is reduced.

However, in practice, in the course of emission from the laser beam source 10 to arrival at the objective lens 47, the state of laser beam L can temporally change due to the influence of fluctuations of the laser beam source 10, disturbance from the optical system, vibration of the stage 20, etc. Thus, to reduce astigmatism and perform shaping into a desired beam shape as described above, it is effective to correct, in real time, the state of laser beam L traveling toward the objective lens 47. Thus, in the present embodiment, the beam shaping unit 40 further includes a feedback control mechanism 60A (see FIG. 2) for correcting the state of laser beam L in real time.

As shown in FIG. 2, the feedback control mechanism 60A includes a feedback controller 60, a first sensor S1, a second sensor S2, a third sensor S3, a fourth sensor S4, a plurality of samplers 61, 62, 63, and 64, an objective lens 65, and an observation objective lens 66.

The feedback controller 60 is a computer including a processor, a memory, etc. The feedback controller 60 executes various control functions by the processor. The feedback controller 60 may be integrated with the control unit 30, or may be separate from the control unit 30. The feedback controller 60 is connected to the sensors S1, S2, S3, and S4 to be able to communicate with these sensors, and acquires beam information φ1, φ2, φ3, and φ4 acquired by the sensors S1, S2, S3, and S4. The beam information φ1, φ2, φ3, and φ4 are information indicating states of laser beam L. As described later, at least one of the beam information φ1, φ2, φ3, and φ4 includes the radius of curvature of the wavefront of laser beam L, the size of the beam shape of laser beam L, the incident position of laser beam L, and the angle of incidence of laser beam L.

As long as reception and delivery of information can be performed with the sensors S1, S2, S3, and S4, the feedback controller 60 may be connected to the sensors S1, S2, S3, and S4 in a wired manner, or may be connected to the sensors S1, S2, S3, and S4 in a wireless manner. The feedback controller 60 is electrically connected to the first beam shaping element D1, and uses the beam information φ1, φ2, φ3, and φ4 from the sensors S1, S2, S3, and S4 to control, in real time, the phase pattern to be presented to the first beam shaping element D1. That is, the feedback controller 60 feeds back the beam information φ1, φ2, φ3, and φ4 indicating states of laser beam L to the first beam shaping element D1. The feedback controller 60 needs only to be able to supply a signal and power to the first beam shaping element D1, and may be indirectly connected to the first beam shaping element D1 with another member interposed therebetween.

The first sensor S1 detects, as a first observation light L1, part of laser beam L traveling from the expanding optical system 43 toward the first beam shaping element D1. The sampler 61 is placed on the optical path P2 of laser beam L between the expanding optical system 43 and the first beam shaping element D1. The first sensor S1 is placed on the optical path of the first observation light L1 reflected by the sampler 61. Therefore, the first sensor S1 is optically coupled to the optical path P2 of laser beam L between the expanding optical system 43 and the first beam shaping element D1. The first sensor S1 is placed at a position having a relationship of being optically conjugate to the first beam shaping element D1. The first observation light L1 reflected by the sampler 61 is incident on the first sensor S1.

The first sensor S1 acquires a first beam information φ1 that is beam information indicating the state of the first observation light L1 and that indicates the state of laser beam L on the irradiated surface of the first beam shaping element D1. The position where the first sensor S1 is installed is a position having a relationship of being conjugate to the first beam shaping element D1. The distance between the sampler 61 and the first sensor S1 is the same as the distance between the sampler 61 and the first beam shaping element D1. The first beam information φ1 includes, for example, the radius of curvature of each of the major axis wavefront AS1 and the minor axis wavefront AS2 of laser beam L, the size of the beam shape of laser beam L, the angle of incidence of laser beam L on the first beam shaping element D1, and the incident position of laser beam L on the first beam shaping element D1. The size of the beam shape of laser beam L is the beam diameter of laser beam L on the irradiated surface of the first beam shaping element D1.

The first sensor S1 includes a wavefront sensor that detects the radius of curvature of each of the major axis wavefront AS1 and the minor axis wavefront AS2 of laser beam L, and a CCD camera that detects the size of the beam shape of laser beam L. The wavefront sensor and the CCD camera may be installed to be interchanged with each other at the same position, or may be installed at positions different from each other. In the case where the wavefront sensor and the CCD camera are installed at positions different from each other, when the distance between the sampler 61 and the first beam shaping element D1, the distance between the sampler 61 and the wavefront sensor, and the distance between the sampler 61 and the CCD camera are the same as each other, the first observation light L1 reflected by the sampler 61 may be branched by a half mirror or the like. The first sensor S1 provides the first beam information φ1 to the feedback controller 60. The first sensor S1 may acquire the first beam information φ1 by using reflected light of a permanently installed sampler.

The feedback controller 60 uses the first beam information φ1 to correct the phase pattern of the first beam shaping element D1. The phase pattern of the first beam shaping element D1 is designed on the premise that laser beam L is incident on the first beam shaping element D1 in a state of collimated light. However, in practice, laser beam L is incident on the first beam shaping element D1 not necessarily in a state where both the major axis wavefront AS1 and the minor axis wavefront AS2 of laser beam L are plane surfaces, but occasionally in a state where at least one of these types of wavefronts is a convex surface or a concave surface. In this case, it is conceivable that, due to the influence of the curvature, the beam shape and the light intensity distribution of laser beam L emitted from the first beam shaping element D1 will deviate from the desired beam shape and light intensity distribution. Thus, the feedback controller 60 performs correction for eliminating the influence of variations in the curvature of laser beam L incident on the first beam shaping element D1.

For example, the feedback controller 60 acquires the radius of curvature included in the first beam information φ1 with a resolution of 10 mm; in the case where at least one of the major axis wavefront AS1 and the minor axis wavefront AS2 of laser beam L traveling toward the first beam shaping element D1 is not a plane surface, the feedback controller 60 corrects the phase pattern of the first beam shaping element D1 so as to offset the curvature of the wavefront. Specifically, the feedback controller 60 gives the first beam shaping element D1 a phase pattern in which the inverse phase of the wavefront of laser beam L is designed. Thereby, the influence of the curvature of laser beam L incident on the first beam shaping element D1 is eliminated. Offsetting the curvature of the wavefront of laser beam L means canceling the curvature of the wavefront of laser beam L, that is, flattening the wavefront of laser beam L.

When correcting the phase pattern of the first beam shaping element D1, the feedback controller 60 adjusts the phase pattern such that the size of the beam shape (that is, the beam diameter) of laser beam L coincides with the aperture diameter of the first beam shaping element D1. For example, the feedback controller 60 acquires the size of the beam shape included in the first beam information φ1 with an accuracy of 0.1 mm, and corrects the phase pattern of the first beam shaping element D1 such that the size of the beam shape coincides with the aperture diameter of the first beam shaping element D1. The feedback controller 60 may correct the size of the beam shape of laser beam L such that the size coincides with the aperture diameter of the first beam shaping element D1.

Thus, the feedback controller 60 outputs, to the first beam shaping element D1, a first correction signal θ1 that corrects the phase of laser beam L such that the curvature of laser beam L is offset and the size of the beam shape of laser beam L becomes equal to or smaller than the aperture diameter of the first beam shaping element D1. The first beam shaping element D1 corrects the phase of laser beam L in accordance with the first correction signal θ1; thereby, a correction that offsets the curvature of the wavefront of at least one of the major axis wavefront AS1 and the minor axis wavefront AS2 of laser beam L and a correction that makes the size of the beam shape of laser beam L equal to or smaller than the aperture diameter of the first beam shaping element D1 are performed.

The second sensor S2 detects, as a second observation light L2, part of laser beam L traveling from the first beam shaping element D1 toward the second beam shaping element D2. The sampler 62 is placed on the optical path P3 of laser beam L between the first beam shaping element D1 and the second beam shaping element D2. The second sensor S2 is placed on the optical path of laser beam L reflected by the sampler 62. Therefore, the second sensor S2 is optically coupled to the optical path P3 of laser beam L between the first beam shaping element D1 and the second beam shaping element D2. The second sensor S2 is placed at a position having a relationship of being optically conjugate to the second beam shaping element D2. The second observation light L2 reflected by the sampler 62 is incident on the second sensor S2.

The second sensor S2 acquires, as a second beam information φ2 indicating the state of laser beam L traveling toward the second beam shaping element D2, beam information indicating the state of the second observation light L2. The second beam information φ2 includes, for example, the radius of curvature of each of the major axis wavefront AS1 and the minor axis wavefront AS2 of laser beam L, the size of the beam shape of laser beam L, the incident position of laser beam L on the second beam shaping element D2, and the angle of incidence of laser beam L on the second beam shaping element D2. The size of the beam shape of laser beam L is the width in the major axis direction A1 of laser beam L after shaping by the first beam shaping element D1 and the width in the minor axis direction A2 of laser beam L after shaping by the first beam shaping element D1.

The second sensor S2 includes a wavefront sensor that detects the radius of curvature of each of the major axis wavefront AS1 and the minor axis wavefront AS2 of laser beam L, and a CCD camera that detects the size of the beam shape of laser beam L and the incident position of laser beam L on the second beam shaping element D2. The wavefront sensor and the CCD camera may be installed to be interchanged with each other at the same position, or may be installed at positions different from each other like in the first sensor S1. The second sensor S2 provides the second beam information φ2 to the feedback controller 60. The second sensor S2 may acquire the second beam information φ2 by using reflected light of a permanently installed sampler.

The feedback controller 60 uses the second beam information φ2 to check the state of laser beam L emitted from the first beam shaping element D1. For example, the feedback controller 60 determines whether correction of the phase pattern of the first beam shaping element D1 based on the first correction signal θ1 has been appropriately performed or not. The feedback controller 60 determines whether the incident position of laser beam L on the second beam shaping element D2 deviates from a reference position or not. The reference position is, for example, the position of the center coordinates of the second beam shaping element D2. The phase pattern of the second beam shaping element D2 is designed on the premise that laser beam L is incident on the reference position of the second beam shaping element D2. Therefore, if laser beam L is incident on a position deviating from the reference position of the second beam shaping element D2, it is conceivable that the beam shape and the light intensity distribution of laser beam L emitted from the second beam shaping element D2 will deviate from the desired beam shape and light intensity distribution. Thus, the feedback controller 60 performs correction for compensating for the deviation of the incident position of laser beam L on the second beam shaping element D2.

For example, the feedback controller 60 outputs, to the first beam shaping element D1, a second correction signal θ2 that superimposes a deflection angle component on the phase pattern of the first beam shaping element D1 so that the deviation of the incident position of laser beam L with respect to the reference position of the second beam shaping element D2 is reduced. The first beam shaping element D1 corrects the phase of laser beam L in accordance with the second correction signal θ2; thereby, a correction that causes the incident position of laser beam L to coincide with the reference position of the second beam shaping element D2 is performed.

The feedback controller 60 may correct the angle of incidence of laser beam L on the first beam shaping element D1 so that the deviation of the incident position of laser beam L with respect to the reference position of the second beam shaping element D2 is reduced. The feedback controller 60 may perform both a correction that superimposes a deflection angle component on the phase pattern of the first beam shaping element D1 and a correction of the angle of incidence of laser beam L on the first beam shaping element D1. The deviation of the incident position of laser beam L with respect to the reference position of the second beam shaping element D2 may be corrected with an accuracy of, for example, 1 μm or less or 0.5 μm or less. The angle of incidence of laser beam L on the first beam shaping element D1 may be corrected with an accuracy of, for example, 0.1°.

The third sensor S3 detects, as third observation light L3, a part of the laser light L traveling from the reduction optical system 45 toward the objective lens 47. The sampler 63 is placed on the optical path P5 of laser beam L between the reduction optical system 45 and the objective lens 47. As the objective lens 65, for example, the same type as that of the objective lens 47 for processing is used. The objective lens 65 is placed on the optical path of laser beam L reflected by the sampler 63. The objective lens 65 is placed at a position having a relationship of being optically conjugate to the objective lens 47. The third sensor S3 is placed on the optical axis of the objective lens 65, and acquires the condensation state of the objective lens 65 by means of the observation objective lens 66. Therefore, the third sensor S3 is optically coupled to the optical path P5 of laser beam L between the reduction optical system 45 and the objective lens 47. The third observation light L3 reflected by the sampler 63 is incident on the third sensor S3 through the objective lens 65 and the observation objective lens 66.

The third sensor S3 includes, for example, a CCD camera. The third sensor S3 acquires, as third beam information φ3 indicating the state of the laser light L directed toward the objective lens 47, beam information indicating the state of the third observation light L3. The third beam information φ3 includes, for example, a light intensity distribution along the optical axis direction of laser beam L. The light intensity distribution along the optical axis direction of laser beam L is observed with a resolution of, for example, 1 μm or less.

The feedback controller 60 uses the third beam information φ3 to determine whether astigmatism has occurred in laser beam L condensed by the objective lens 47 or not. Specifically, the feedback controller 60 determines whether a deviation in the optical axis direction between the focal position fp1 (see FIG. 3A) of laser beam L for the major axis direction A1 and the focal position fp2 (see FIG. 3B) of laser beam L for the minor axis direction A2 has occurred or not. In the case where a deviation between the focal positions fp1 and fp2 has occurred, the feedback controller 60 outputs, to the first beam shaping element D1, a third correction signal θ3 that corrects the phase of the first beam shaping element D1 so that the deviation is reduced.

For example, in the case where the minor axis wavefront AS2 of laser beam L is a plane surface, the feedback controller 60 may correct the radius of curvature of the major axis wavefront AS1 of laser beam L to the negative side or the positive side. More specifically, when the radius of curvature of the minor axis wavefront AS2 of laser beam L is as large as 10 m and the minor axis wavefront AS2 can be regarded as a plane surface, the feedback controller 60 may shift the radius of curvature of the major axis wavefront AS1 to the negative side or the positive side with a resolution of 10 cm. Thereby, the deviation between the focal positions fp1 and fp2 can be adjusted to fall within a desired range. The first beam shaping element D1 corrects the phase of laser beam L in accordance with the third correction signal θ3; thereby, a correction that reduces the deviation between the focal positions fp1 and fp2 is performed.

The fourth sensor S4 detects, as a fourth observation light L4, part of laser beam L traveling from the reduction optical system 45 toward the objective lens 47. The sampler 64 is placed on the optical path P5 of laser beam L between the reduction optical system 45 and the objective lens 47. The fourth sensor S4 is placed on the optical path of the fourth observation light L4 reflected by the sampler 64. Therefore, the fourth sensor S4 is optically coupled to the optical path P5 of laser beam L between the reduction optical system 45 and the objective lens 47. The fourth sensor S4 is placed at a position having a relationship of being optically conjugate to the objective lens 47. The fourth observation light L4 reflected by the sampler 64 is incident on the fourth sensor S4.

The fourth sensor S4 acquires, as a fourth beam information φ4 indicating the state of laser beam L traveling toward the objective lens 47, beam information indicating the state of the fourth observation light L4. The fourth beam information φ4 includes, for example, at least the radius of curvature of each of the major axis wavefront AS1 and the minor axis wavefront AS2 of laser beam L incident on the objective lens 47 and the size of the beam shape of laser beam L traveling toward the objective lens 47. The size of the beam shape of laser beam L is the width in the major axis direction A1 of laser beam L after being shaped by the second beam shaping element D2 and passing through the reduction optical system 45, and the width in the minor axis direction A2 of laser beam L after shaping by the second beam shaping element D2.

The fourth sensor S4 includes a wavefront sensor that detects the radius of curvature of each of the major axis wavefront AS1 and the minor axis wavefront AS2 of laser beam L, and a CCD camera that detects the size of the beam shape of laser beam L. The wavefront sensor and the CCD camera may be installed to be interchanged with each other at the same position, or may be installed at positions different from each other like in the first sensor S1, the second sensor S2, and the third sensor S3. The fourth sensor S4 provides the fourth beam information φ4 to the feedback controller 60. The fourth sensor S4 may acquire the fourth beam information φ4 by using reflected light of a permanently installed sampler.

The feedback controller 60 uses the fourth beam information φ4 to determine whether the major axis wavefront AS1 and the minor axis wavefront AS2 of laser beam L traveling toward the objective lens 47 are plane surfaces or not. In the case where at least one of the major axis wavefront AS1 and the minor axis wavefront AS2 of laser beam L is not a plane surface, the feedback controller 60 corrects the phase pattern of the first beam shaping element D1 so as to offset the curvature of the wavefront. Specifically, the feedback controller 60 outputs, to the first beam shaping element D1, a fourth correction signal θ4 that gives the first beam shaping element D1 a phase pattern in which the inverse phase of the wavefront of laser beam L is designed. The first beam shaping element D1 corrects the phase of laser beam L in accordance with the fourth correction signal θ4; thereby, a correction that offsets the curvature of the wavefront of at least one of the major axis wavefront AS1 and the minor axis wavefront AS2 of laser beam L is performed.

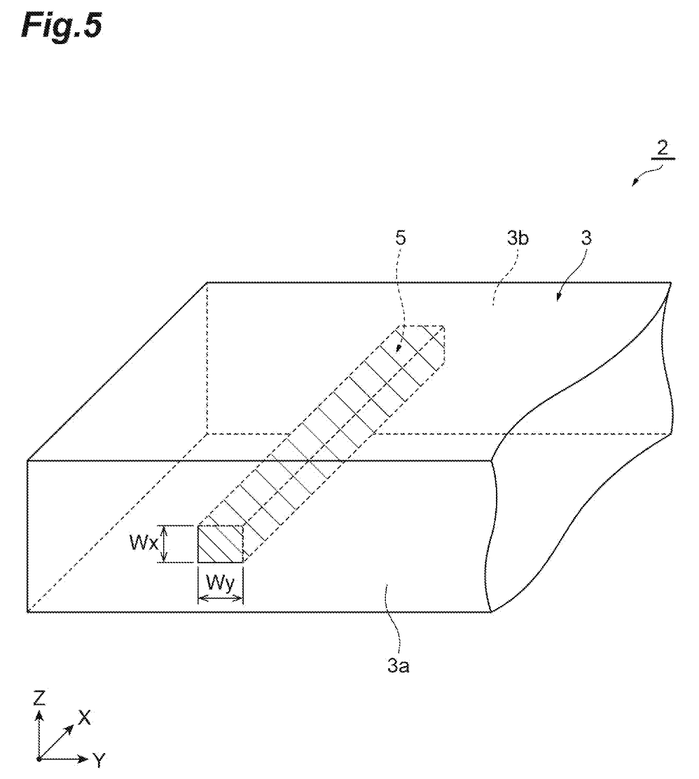

FIG. 5 is a perspective view schematically showing an optical connection component 2 manufactured using the manufacturing apparatus 1. As shown in FIG. 5, the optical connection component 2 includes a glass member 3 and an optical waveguide 5 formed in the inside the glass member 3. The glass member 3 is, for example, a plate-shaped member of which the thickness direction is the Z-axis direction. The glass member 3 includes a first end face 3a and a second end face 3b arranged along the X-axis direction. The first end face 3a and the second end face 3b are, for example, planes extending along the Z-axis direction and the Y-axis direction. A first end of the optical waveguide 5 is exposed from the first end face 3a. A second end of the optical waveguide 5 is exposed from the second end face 3b.

The glass member 3 is formed of a glass material such as phosphate-based glass (P₂O₅-based glass) or silicate-based glass (SiO₂-based glass). In an example, the glass member 3 is made of phosphate-based glass or silicate-based glass containing an additive material. The glass member 3 may contain Ge (germanium) as an additive material, or may contain B (boron) as an additive material. The glass member 3 may contain any one of alkaline earth metal elements such as Be, Mg, Ca, Sr, Ba, and Ra alone, or may contain a plurality of these alkaline earth metal elements. In this case, these additive materials may be uniformly distributed throughout the entire glass member 3.

The optical waveguide 5 formed in the inside the glass member 3 is a continuous refractive index-changed region formed by photoinduction. The refractive index-changed region is formed by condensing pulsed laser beam L to the inside the glass member 3 and continuously moving the focal point 3p. The optical waveguide 5 extends in a straight line along the X-axis direction from the first end face 3a to the second end face 3b, for example. The optical waveguide 5 may have, in the inside the glass member 3, a three-dimensional solid structure that changes in the X-axis direction, the Y-axis direction, and the Z-axis direction. In a cross section perpendicular to the X-axis direction, along which the optical waveguide 5 extends (that is, the optical axis direction of the optical waveguide 5), the shape of the optical waveguide 5 is, for example, a rectangular shape having the longitudinal direction is the Y-axis direction. The width Wy of the optical waveguide 5 along the Y-axis direction may be the same as the width Wx of the optical waveguide 5 along the Z-axis direction (Wy = Wx), may be longer than the width Wx of the optical waveguide 5 (Wy > Wx), or may be shorter than the width Wx of the optical waveguide 5 (Wy < Wx).

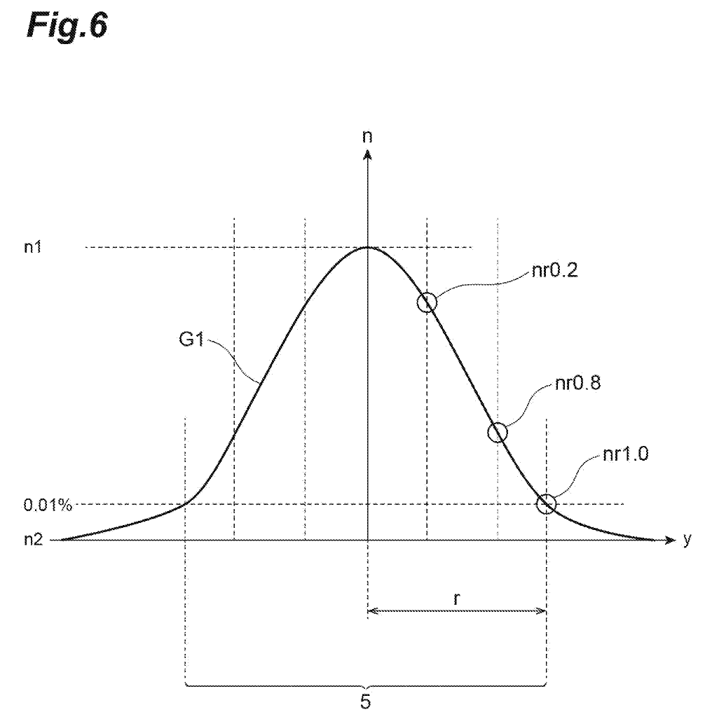

FIG. 6 is a graph showing a refractive index distribution G1 of the optical waveguide 5 along the Y-axis direction. The vertical axis of FIG. 6 represents the refractive index n of the optical waveguide 5 along the Y-axis direction, and the horizontal axis of FIG. 6 represents the position of the optical waveguide 5 along the Y-axis direction. The shape of the refractive index distribution G1 of the optical waveguide 5 along the Y-axis direction is not a common step-index type but a Gaussian type like that shown in FIG. 6. The shape of the refractive index distribution G1 may be a graded index type or an α-th power type. In the refractive index distribution G1 shown in FIG. 6, when the maximum value of the refractive index n is denoted by n1 and the average value of the refractive indices n of the region of the glass member 3 not irradiated with laser beam L (that is, the region of the glass member 3 excluding the optical waveguide 5) is denoted by n2, the area of n2 + 0.01% or more including the refractive index n1 can be defined as the extent of the optical waveguide 5. In this case, the position where the refractive index n is n2 + 0.01% can be defined as the outer edge of the optical waveguide 5. The position of the refractive index n1 can be defined as the center of the optical waveguide 5.

In FIG. 6, when the distance from the center to the outer edge of the optical waveguide 5 along the Y-axis direction is denoted by r, the distance r is, for example, 2 μm or more and 5 μm or less. When the refractive index n at the position of the outer edge of the optical waveguide 5 is denoted by a refractive index nr1.0, the refractive index n at a position away from the center of the optical waveguide 5 by 20% of the distance r is denoted by a refractive index nr0.2, and the refractive index n at a position away from the center of the optical waveguide 5 by 80% of the distance r is denoted by a refractive index nr0.8, the ratio (nr0.2/n1) of the refractive index nr0.2 to the refractive index n1 is, for example, 85% or more and 100% or less, and the ratio (nr0.8/n1) of the refractive index nr0.8 to the refractive index n1 is, for example, 8% or more and 75% or less. The refractive index difference of the refractive index n1 with respect to the refractive index n2 is, for example, 0.2% or more and 0.8% or less. The transmission loss in the case where an optical connection component 2 including an optical waveguide 5 having the refractive index distribution G1 shown in FIG. 6 is used is, for example, less than 0.1 dB/cm. Examples of methods for measuring the refractive index difference include, for example, a method of estimating the refractive index difference by comparing a near-field image of the waveguide with a guided mode obtained from the refractive index difference and the core shape of the waveguide. However, the method for measuring the refractive index difference is not limited to the above-described method, and may also include a method of measuring the OPD (Optical Path Difference), which is the product of the refractive index difference and the thickness, with a quantitative phase microscope after slicing the waveguide to approximately 50 μm, and then dividing by the thickness to determine the refractive index difference.

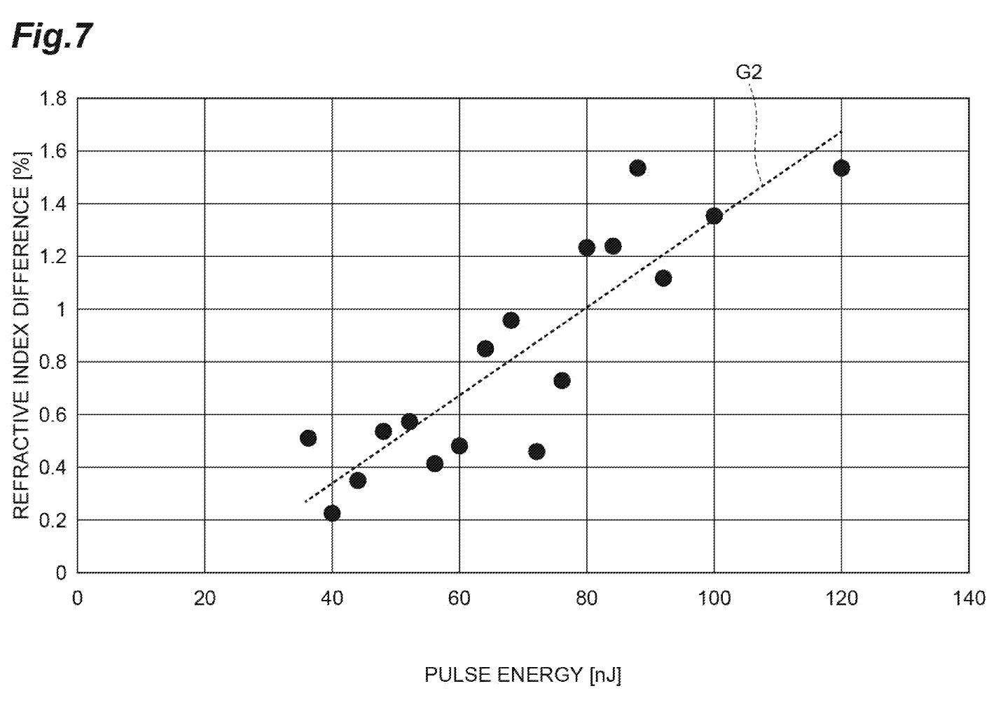

FIG. 7 is a diagram showing a relationship between the pulse energy of laser beam L and the refractive index difference of the optical waveguide 5 (core) with respect to pure quartz (cladding), which is an example of the material of the glass member 3. FIG. 7 shows a result obtained under the following irradiation conditions of laser beam L.

Average power: 10 mW or more and 500 mW or less

Condensing diameter: 1 μm

Pulse width: 150 fs or more and 300 fs or less

Wavelength: 515 nm

Repetition frequency: 100 kHz or more and 2 MHz or less

Scanning speed: 1 μm/sec or more and 3000 μm/sec or less

As shown in FIG. 7, it can be seen that there is a tendency that, as the pulse energy of laser beam L increases, also the refractive index difference increases. When the pulse energy is denoted by x and the refractive index difference is denoted by y, an approximate expression (relational expression) indicating the relationship between the pulse energy x and the refractive index difference y is represented by y = 0.0168x - 0.3354, and an approximate line G2 indicated by this approximate expression is shown in FIG. 7. The light intensity distribution in the Y-axis direction of laser beam L to be applied to the glass member 3 is designed using the approximate line G2 of FIG. 7 on the basis of the refractive index distribution G1 of FIG. 6. For example, when the distance r is set to 2 μm, since the condensing diameter is 1 μm, desired refractive indices are set such that n1 = 0.4 %, nr0.5 = 0.3 %, and nr1.0 = 0.1% for diameter direction coordinates of 0 μm, 1 μm, and 2 μm (the horizontal axis of FIG. 6). Then, a desired pulse energy is obtained from the above approximate line G2, and the pulse energy is multiplied by the repetition frequency among the above irradiation conditions; thereby, necessary optical power can be obtained.

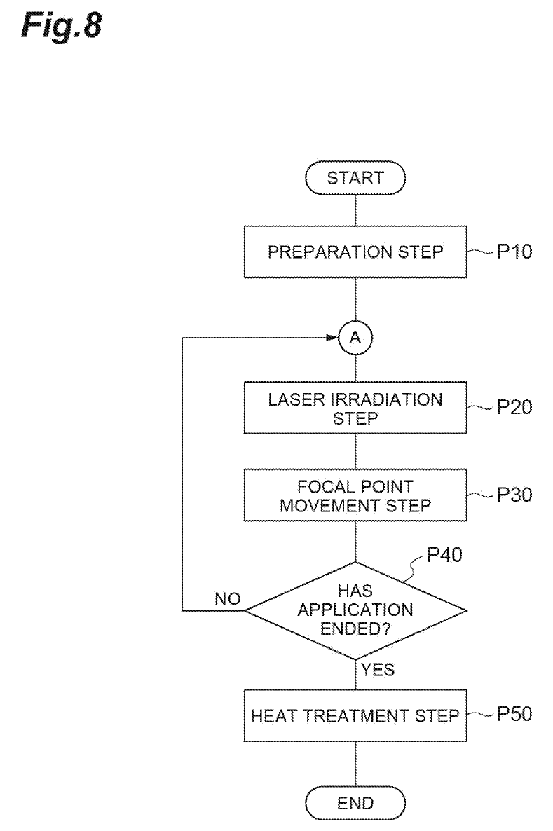

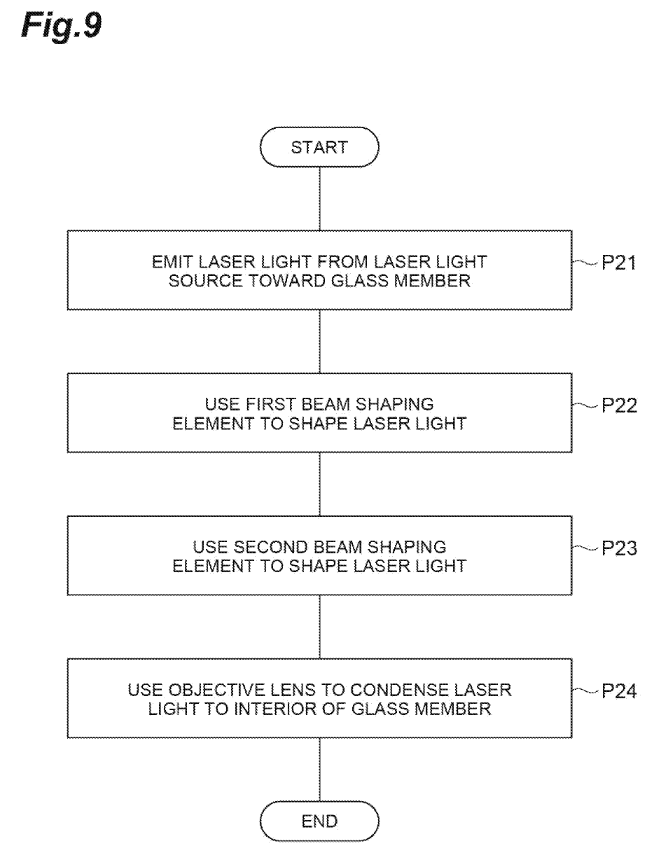

A manufacturing method performed using the manufacturing apparatus 1 described above will now be described with reference to FIGS. 8 and 9. FIG. 8 is a flowchart for describing an example of a manufacturing method of the present embodiment; FIG. 9 is a flowchart for describing an example of steps included in FIG. 8;

First, in a preparation step, a glass member 3 that will form an optical connection component 2 is prepared (step P10 of FIG. 8). The glass member 3 is mounted on the mounting surface 20a of the stage 20.

Next, in a laser irradiation step, laser beam L is applied to the inside the glass member 3 (step P20 of FIG. 8). At this time, the power of laser beam L is set to a magnitude for reformation to start, the focal point is adjusted to be on the surface of the glass member 3, and a height reference in the Z-axis direction is set. Next, the glass member 3 is removed from the processing area in order to avoid unnecessary alteration. The control unit 30 controls the laser driving unit 15 such that laser beam L having an amount of energy that causes a refractive index change based on photoinduction in the inside the glass member 3 and having a repetition frequency of 10 kHz or more is outputted from the laser beam source 10. Laser beam L emitted from the laser beam source 10 is confirmed to be shaped into a desired beam shape by the beam shaping unit 40, and is then condensed to a focal point 3p in the inside the glass member 3. As a possible example of the method for determining whether shaping into a desired beam shape has been performed or not, the following method is given. First, in step P10 (the preparation step), the output of power of laser beam L is reduced. Then, while the position of the observation objective lens 66, on which reflected light from the sampler 63 is incident, is shifted in the Z-axis direction, the depth of focus of beam shaping and the intensity distribution of laser beam L are observed.

In the laser irradiation step, first, the laser beam source 10 emits laser beam L toward the glass member 3 (step P21 of FIG. 9). The laser beam L emitted from the laser beam source 10 is expanded by the expanding optical system 43, and is then incident on the first beam shaping element D1.

Next, the first beam shaping element D1 shapes the laser beam L such that the width in the major axis direction A1 of the beam shape of laser beam L is different from the width in the minor axis direction A2 (step P22 of FIG. 9). For example, the first beam shaping element D1 condenses the laser beam L in the major axis direction A1, and thereby makes the width in the major axis direction A1 of the beam shape of laser beam L smaller than the width in the minor axis direction A2. The laser beam L condensed in the major axis direction A1 by the first beam shaping element D1 is incident on the second beam shaping element D2.

Next, the second beam shaping element D2 shapes the laser beam L such that both the major axis wavefront AS1 and the minor axis wavefront AS2 of laser beam L become plane wavefronts (step P23 of FIG. 9). The laser beam L of which the major axis wavefront AS1 and the minor axis wavefront AS2 have been adjusted to plane surfaces by the second beam shaping element D2 is reduced by the reduction optical system 45, and is then incident on the objective lens 47.

Next, the objective lens 47 condenses the laser beam L to a focal point 3p in the inside the glass member 3 such that the beam shape at the focal point 3p is a shape having a minor axis AX2 and a major axis AX1 (step P24 of FIG. 9). At this time, the laser beam L is condensed up to the diffraction limit in the minor axis direction A2 by the objective lens 47. As a result, the width in the major axis direction A1 of the beam shape of laser beam L after condensation is larger than the width in the minor axis direction A2 of the beam shape, and the beam shape at the focal point 3p in the inside the glass member 3 is shaped into an elliptical shape or a line beam shape having a minor axis AX2 and a major axis AX1. Then, a refractive index change based on photoinduction occurs in the beam irradiation region R at the focal point 3p.

When laser application to the glass member 3 is completed by the above laser irradiation step, the control unit 30 controls the stage driving unit 25 to move the position of the glass member 3 mounted on the mounting surface 20a of the stage 20 (step P30 of FIG. 8). Specifically, the control unit 30 continuously or intermittently changes the installation position of the glass member 3 or the position of the focal point 3p of laser beam L, or both of these positions, and thereby moves the position of the focal point 3p of laser beam L in the inside the glass member 3.

Next, the control unit 30 determines whether a pattern of an optical waveguide 5 designed in advance has been formed in the inside the glass member 3 by steps P20 and P30 or not, and thereby determines whether application of laser beam L to the glass member 3 has ended or not (step P40 of FIG. 8). In the case where the control unit 30 has determined that application of laser beam L has not ended (NO in step P40 of FIG. 8), the control unit 30 returns to the A point of FIG. 8, and repeats steps P20 and P30. On the other hand, in the case where when the control unit 30 has determined that application of laser beam L has ended (YES in step P40 of FIG. 8), the control unit 30 determines that the formation of an optical waveguide 5 on the glass member 3 is completed. After that, in order to suppress a change in the refractive index of the glass member 3 over a long period of time, heat treatment for aging treatment is performed on the glass member 3 (step P50 of FIG. 8). Through the above steps, an optical connection component 2 in which an optical waveguide 5 is formed in the inside the glass member 3 (see FIG. 5) is obtained.

Effects obtained by the manufacturing apparatus 1 of the present embodiment described hereinabove will now be described together with problems that a comparative example involves.

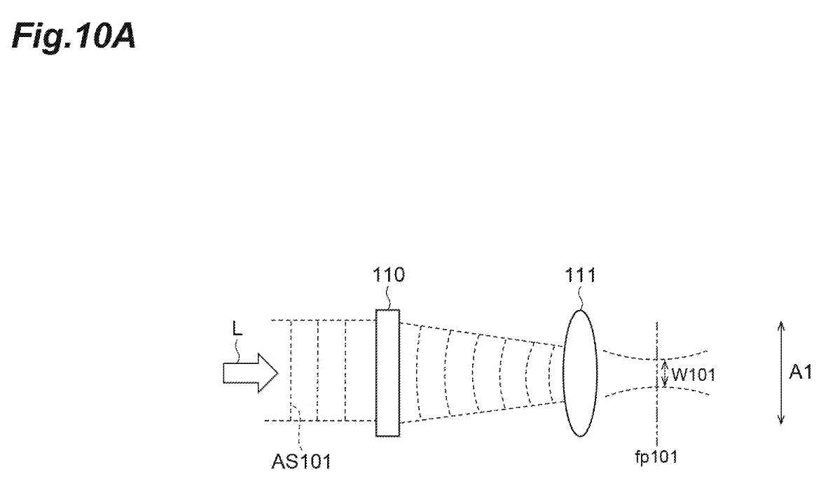

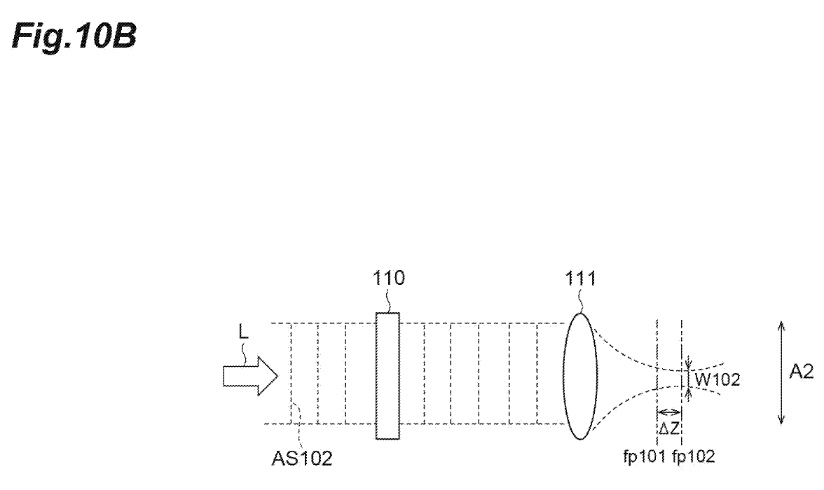

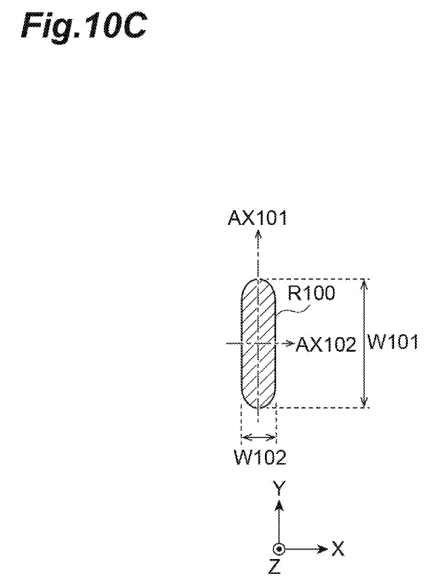

FIG. 10A is a diagram showing changes of the state of the major axis wavefront AS101 of laser beam L shaped by a manufacturing apparatus of a comparative example. FIG. 10B is a diagram showing changes of the state of the minor axis wavefront AS102 of laser beam L shaped by the manufacturing apparatus of the comparative example. FIG. 10C is a diagram showing a beam irradiation region R100 of laser beam L condensed by the manufacturing apparatus of the comparative example.

In the example shown in FIGS. 10A to 10C, laser beam L is shaped by a beam shaping element 110, and is then condensed by an objective lens 111. As a result, the beam irradiation region R100 of laser beam L after condensation is, as shown in FIG. 10C, in an elliptical shape having a major axis AX101 and a minor axis AX102.

As shown in FIGS. 10A and 10B, the beam shaping element 110 condenses laser beam L in the major axis direction A1, but in the minor axis direction A2 maintains laser beam L as collimated light without condensation. In this case, the minor axis wavefront AS102 of laser beam L is a plane surface, whereas the major axis wavefront AS101 of laser beam L is a concave surface having a certain radius of curvature. When laser beam L is incident on the objective lens 111 in a state where the curvatures of the minor axis wavefront AS102 and the major axis wavefront AS101 do not coincide with each other as above, a large deviation ΔZ occurs between the focal position fp101 of laser beam L for the major axis direction A1 and the focal position fp102 of laser beam L for the minor axis direction A2 due to the influence of the difference in curvature. That is, a large astigmatism occurs in laser beam L after condensation by the objective lens 111.

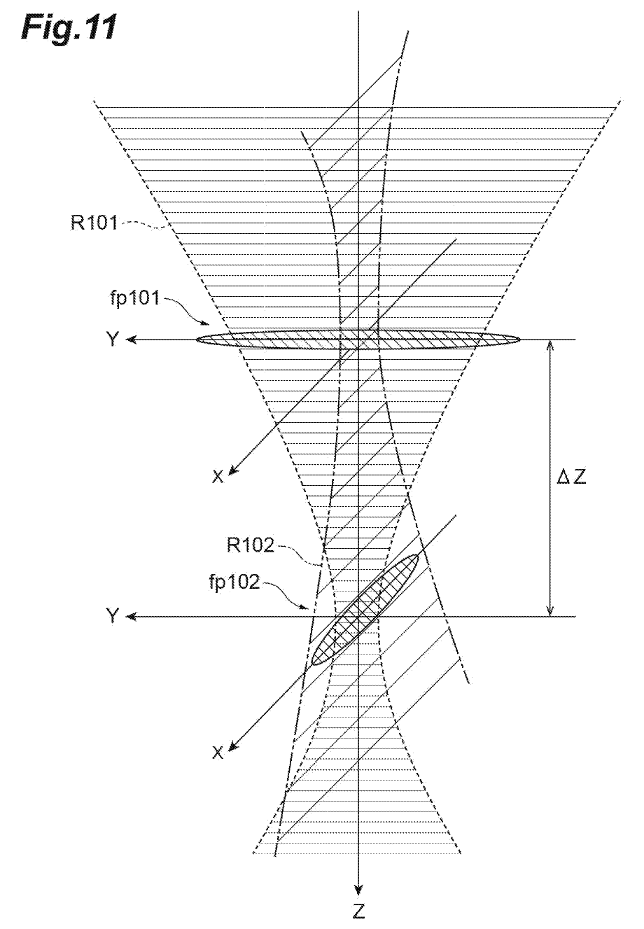

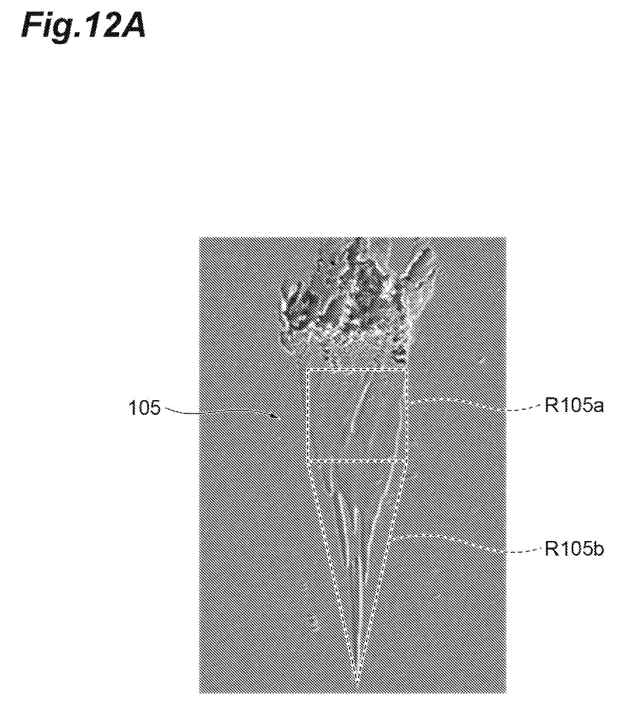

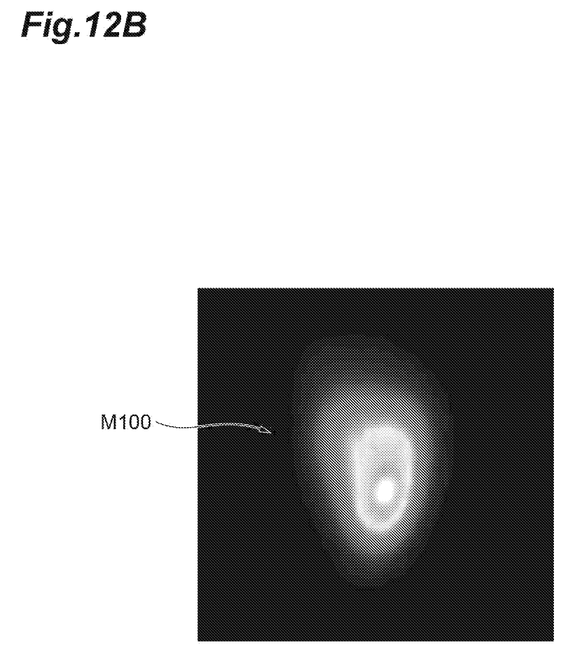

FIG. 11 is a diagram showing a beam cross section along the optical axis direction of laser beam L condensed by the manufacturing apparatus of the comparative example. In FIG. 11, a beam cross section R101 of laser beam L along the Z-axis direction, which is the optical axis direction, and the Y-axis direction, which is the major axis direction A1, and a beam cross section R102 of laser beam L along the Z-axis direction, which is the optical axis direction, and the X-axis direction, which is the minor axis direction A2, are shown in an overlapping manner. FIG. 12A is a diagram showing a cross-sectional shape of an optical waveguide 105 that is formed in the inside a glass member 3 by the manufacturing apparatus of the comparative example. FIG. 12B is a diagram showing a shape of a waveguiding mode M100 of propagation through the optical waveguide 105 shown in FIG. 12A. In FIG. 12A, an etching image after the cross section of the optical waveguide 105 of the glass member 3 is polished is shown. The purpose of the etching is to facilitate recognition of the cross-sectional shape of the optical waveguide 105, which is the region modified by application of laser beam L, by using the difference in the etching rate ratio between the modified region and the unmodified region.

As shown in FIG. 11, in the beam cross section R101, a focal position fp101 that is the position of a beam waist of laser beam L for the Y-axis direction is shown. In the beam cross section R102, a focal position fp102 that is the position of a beam waist of laser beam L for the X-axis direction is shown. The focal position fp102 is greatly shifted from the focal position fp101 along the Z-axis direction. In this case, as a result of progress of modification based on application of laser beam L not only at the focal position fp101 but also at the focal position fp102, as shown in FIG. 12A, the cross-sectional shape of the optical waveguide 105 is an inverted bell shape extending in the Z-axis direction, which is the optical axis direction. That is, the cross-sectional shape of the optical waveguide 105 has, in addition to a rectangular cross-sectional region R105a, a cross-sectional region R105b extending in the Z-axis direction from the cross-sectional region R105a, and is a shape greatly distorted from a rectangular shape. With the distortion of the cross-sectional shape of the optical waveguide 105, as shown in FIG. 12B, a waveguiding mode M100 of propagation through the optical waveguide 105 has a shape greatly distorted from a perfect circle. If an optical connection component in which such an optical waveguide 105 is formed is connected to a connection destination component such as an SMF, the optical coupling efficiency of them is reduced, and light transmission loss is increased.

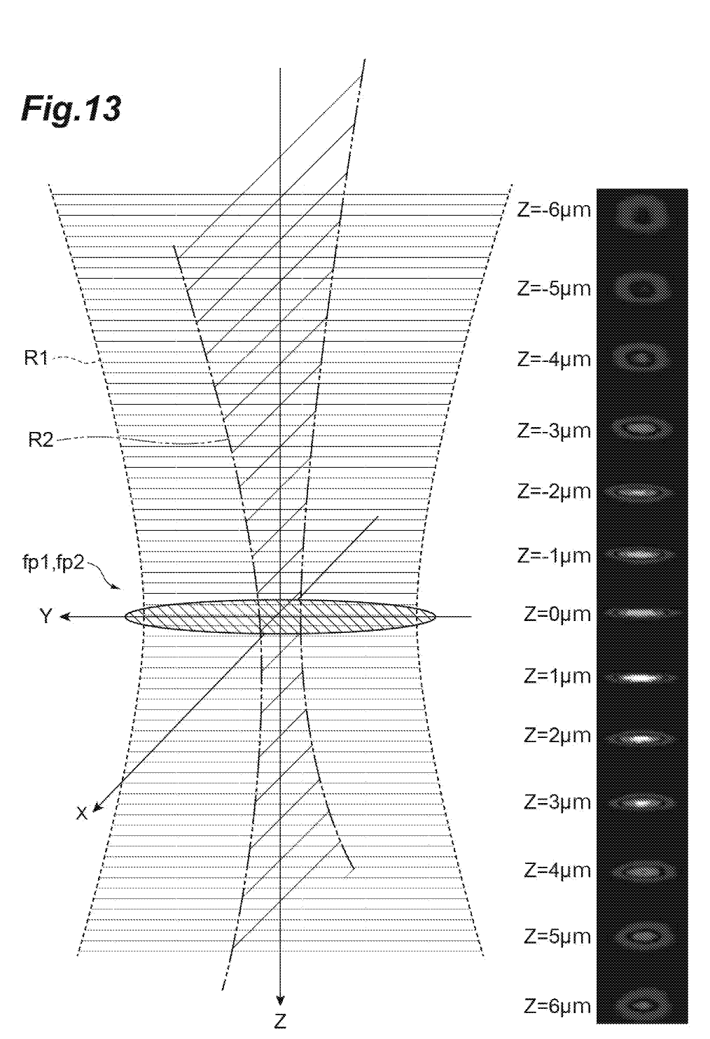

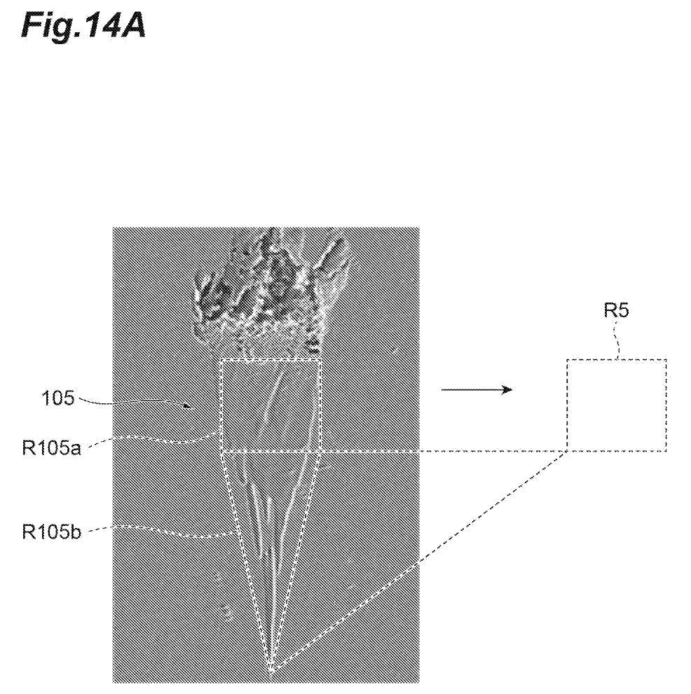

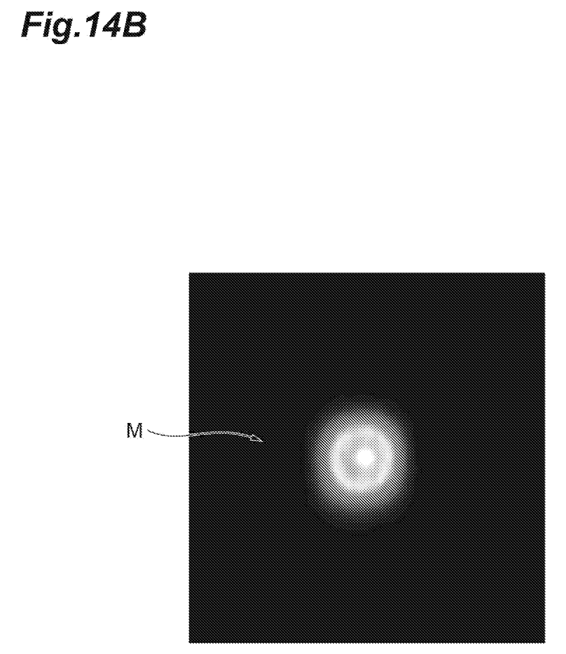

FIG. 13 is a diagram showing a beam cross section along the optical axis direction of laser beam L condensed by the manufacturing apparatus 1 of the present embodiment. In FIG. 13, a beam cross section R1 of laser beam L along the Z-axis direction, which is the optical axis direction, and the Y-axis direction, which is the major axis direction A1, and a beam cross section R2 of laser beam L along the Z-axis direction, which is the optical axis direction, and the X-axis direction, which is the minor axis direction A2, are shown in an overlapping manner. In FIG. 13, an observation image of a light intensity distribution along the Z-axis direction is also shown. FIG. 14A is a diagram showing an image of a cross-sectional shape of an optical waveguide 5 that is formed in the inside a glass member 3 by the manufacturing apparatus 1 of the present embodiment. FIG. 14B is a diagram showing a shape of a waveguiding mode M of propagation through the optical waveguide 5 shown in FIG. 14A.

In the present embodiment, as described above, before laser beam L is condensed by the objective lens 47, laser beam L is shaped such that both the major axis wavefront AS1 and the minor axis wavefront AS2 become plane surfaces. In this case, since the difference between the radius of curvature of the major axis wavefront AS1 and the radius of curvature of the minor axis wavefront AS2 can be reduced, astigmatism occurring due to the difference between them can be reduced. That is, as shown in FIG. 13, a focal position fp1 that is the position of a beam waist of laser beam L for the Y-axis direction coincides with a focal position fp2 that is the position of a beam waist of laser beam L for the X-axis direction, or is formed at a position very close to the focal position fp2. That is, in the present embodiment, the light focal positions fp1 and fp2 are not present at two places widely away from each other along the Z-axis direction. In this case, as shown in FIG. 13, the focal point 3p at which the light intensity of laser beam L is maximized is formed only at one place.

By virtue of the fact that modification based on application of laser beam L progresses at one place along the Z-axis direction, as shown in FIG. 14A, the cross-sectional shape of the optical waveguide 5 formed by laser beam L can be made a shape having only a rectangular cross-sectional region R5, that is, a shape excluding a portion corresponding to the cross-sectional region R105b of the optical waveguide 105 of the comparative example. As a result, as shown in FIG. 14B, the waveguiding mode M of propagation through the optical waveguide 5 can be brought close to a perfect circle. Thus, by the present embodiment, the risk that the modified region in the inside the glass member 3 formed by application of laser beam L will be extended in the optical axis direction can be reduced, and accordingly distortion of the cross-sectional shape of the optical waveguide 5 formed in the inside the glass member 3 can be reduced. As a result, failure of the waveguiding mode M of propagation through the inside the optical waveguide 5 can be reduced, and accordingly transmission loss can be reduced.

Effects obtained by the optical connection component 2 manufactured by the manufacturing apparatus 1 of the present embodiment will now be described.

In the conventional technology, an optical waveguide having a refractive index distribution of a step-index type may be formed. In this case, transmission loss may be increased by non-uniformity of the optical waveguide due to the laser beam source and the optical system. In contrast, in the optical connection component 2 of the present embodiment, the refractive index distribution G1 of the optical waveguide 5 along the Y-axis direction can be made a graded index type in which the refractive index difference at the boundary between the optical waveguide 5 (core) and the surrounding region (cladding) is reduced. In an optical waveguide 5 thus having a refractive index distribution G1 with a small refractive index difference, even if non-uniformity occurs with the optical waveguide 5 due to the laser beam source 10 and the optical system, transmission loss due to the non-uniformity can be reduced.

As in the present embodiment, the distance r may be 2 μm or more and 5 μm or less. In this case, an optical waveguide 5 having an appropriate size capable of reducing transmission loss can be obtained.

As in the present embodiment, the refractive index difference of the refractive index n1 with respect to the refractive index n2 may be 0.2% or more and 0.5% or less. In this case, the refractive index difference at the boundary between the optical waveguide 5 (core) and the surrounding region (cladding) can be made smaller, and therefore transmission loss can be reduced more effectively.

As in the present embodiment, the light intensity distribution of laser beam L along the major axis direction A1 in the beam shape at the focal point 3p may be set using an approximate line G2 indicating a relationship between the pulse energy of laser beam L and the refractive index difference of the optical waveguide 5 with respect to the glass member 3, and a refractive index distribution G1 of the optical waveguide 5 along the Y axis direction. In this case, by application of laser beam L to the glass member 3, an optical waveguide 5 having a refractive index distribution G1 with a small refractive index difference as described above can be easily formed.

The optical connection component of the present disclosure is not limited to the embodiment described above, and can be modified without departing from the spirit of the claims. In the embodiment described above, a case where the first beam shaping element D1 is an LCoS-SLM and the second beam shaping element D2 is a bulk DOE is described. Both the first beam shaping element D1 and the second beam shaping element D2 may be LCoS-SLMs. Alternatively, the first beam shaping element D1 may be a bulk DOE, and the second beam shaping element D2 may be an LCoS-SLM. One of the first beam shaping element D1 and the second beam shaping element D2 may be a concave lens or a convex lens. Therefore, the combination of the first beam shaping element D1 and the second beam shaping element D2 is not limited to a combination of an LCoS-SLM and a bulk DOE, and may be a combination of an LCoS-SLM and an LCoS-SLM, a combination of an LCoS-SLM and a concave lens, or a combination of a convex lens and an LCoS-SLM.

The arrangement of optical elements included in the beam shaping unit is not limited to the example shown in FIG. 2. The number, sizes, and arrangement of optical elements such as the first beam shaping element and the second beam shaping element can be changed according to required specifications, etc., as appropriate. Although a case where the feedback control mechanism 60A includes the first sensor S1, the second sensor S2, the third sensor S3, and the fourth sensor S4 is described in FIG. 2, it is not always necessary to include all of the first sensor S1, the second sensor S2, the third sensor S3, and the fourth sensor S4, and some sensors may be omitted. Alternatively, the feedback control mechanism 60A may further include another sensor in addition to the first sensor S1, the second sensor S2, the third sensor S3, and the fourth sensor S4.

WHAT IS CLAIMED IS:

1. An optical connection component comprising:
a glass member; and
an optical waveguide formed in an inside the glass member and having a higher refractive index than the glass member, wherein,
in a cross section orthogonal to a direction in which the optical waveguide extends, a width of the optical waveguide along a first direction is equal to or different from a width of the optical waveguide along a second direction orthogonal to the first direction,
in a refractive index distribution of the optical waveguide along the first direction, when a maximum value of a refractive index of the optical waveguide is denoted by n1 and an average value of refractive indices of a region of the glass member excluding the optical waveguide is denoted by n2, an area of the refractive index n2 + 0.01% or more including the refractive index n1 is defined as an extent of the optical waveguide, and
when a distance from a center to an outer edge of the optical waveguide along the first direction is denoted by r, a refractive index at a position of the outer edge of the optical waveguide is denoted by nr1.0, a refractive index at a position away from the center of the optical waveguide by 20% of the distance r is denoted by nr0.2, and a refractive index at a position away from the center of the optical waveguide by 80% of the distance r is denoted by nr0.8,
a ratio (nr0.2/n1) of the refractive index nr0.2 to the refractive index n1 is 85% or more and 100% or less, and
a ratio (nr0.8/n1) of the refractive index nr0.8 to the refractive index n1 is 8% or more and 75% or less.

2. The optical connection component according to claim 1, wherein
the distance r is 2 μm or more and 5 μm or less.

3. The optical connection component according to claim 1, wherein
a refractive index difference of the refractive index n1 with respect to the refractive index n2 is 0.2% or more and 0.5% or less.
